(19) United States
(12) Patent Application Publication
(10) Pub. No.: US 2024/0348741 A1
(43) Pub. Date: Oct. 17, 2024

(54) CONTROL DEVICE, CONTROL METHOD, AND CONTROL PROGRAM

(71) Applicant: FUJIFILM Corporation, Tokyo (JP)

(72) Inventors: Kazuki ISHIDA, Saitama-shi (JP); Kazuki INOUE, Saitama-shi (JP); Masahiko MIYATA, Saitama-shi (JP)

(73) Assignee: FUJIFILM Corporation, Tokyo (JP)

(21) Appl. No.: 18/755,100

(22) Filed: Jun. 26, 2024

Related U.S. Application Data
(63) Continuation of application No. PCT/JP2022/046070, filed on Dec. 14, 2022.

(30) Foreign Application Priority Data
Dec. 27, 2021 (JP) 2021-212602

(51) Int. Cl. H04N 5/74

(52) U.S. Cl. CPC H04N 5/74

(57) ABSTRACT

A control device that controls a projection apparatus, includes a processor, and the processor is configured to: acquire plural pieces of image data indicating plural images that are to be combined to form an information image; and perform a control of projecting the plural images from the projection apparatus at different timings.

### CROSS REFERENCE TO RELATED APPLICATION

This is a continuation of International Application No. PCT/JP2022/046070 filed on Dec. 14, 2022, and claims priority from Japanese Patent Application No. 2021-212602 filed on Dec. 27, 2021, the entire disclosures of which are incorporated herein by reference.

### BACKGROUND OF THE INVENTION

### 1. Field of the Invention

The present invention relates to a control device, a control method, and a computer readable medium storing a control program.

### 2. Description of the Related Art

JP2021-097294A discloses a drone comprising a projection apparatus that displays a projection video on a projection surface outside the drone, in which in a case where the projection video is enlarged, reduced, or deformed by movement along a direction of an air flow channel, the projection video is corrected to have a predetermined size and a predetermined shape on the projection surface in accordance with a distance from the drone to the projection surface and an angle with respect to the projection surface.

JP2019-008676A discloses a control device that controls a moving object comprising a projection unit and that controls at least one of a position of the moving object, a posture of the moving object, or a direction of the projection unit by referring to a captured image.

JP2015-139004A discloses a video projection apparatus that, in a case where a predetermined object is present at a position of division in dividing an input image in an unsuitable projection region, changes the position of the division to a position at which the object in a region corresponding to the unsuitable projection region is not divided and that projects the divided input images to a region excluding the unsuitable projection region by resizing the input images to fit in the region.

JP2015-130555A discloses an image processing apparatus that, based on information related to a shape of a projection surface to which an image is projected, information related to a position of a viewpoint at which the image projected to the projection surface is observed, and information related to a position of a projection point at which the image is projected, estimates a region which is visible from the viewpoint at which the image projected to the projection surface is observed and that corrects a target image to fit in the region.

### SUMMARY OF THE INVENTION

One embodiment according to the disclosed technology provides a control device, a control method, and a computer readable medium storing a control program that can deliver information based on projection and capturing of an image with high accuracy even in a circumstance in which it is difficult to perform high accuracy projection and imaging.

A control device according to an aspect of the present invention is a control device that controls a projection apparatus, the control device comprising a processor, in which the processor is configured to acquire a plurality of pieces of image data indicating a plurality of images that are combined to form an information image, and perform a control of projecting the plurality of images from the projection apparatus at different timings.

A control method according to another aspect of the present invention is a control method performed by a processor of a control device that controls a projection apparatus, the control method comprising acquiring a plurality of pieces of image data indicating a plurality of images that are combined to form an information image, and performing a control of projecting the plurality of images from the projection apparatus at different timings.

A control program stored in a computer readable medium according to still another aspect of the present invention is a control program for causing a processor of a control device that controls a projection apparatus to execute a process comprising acquiring a plurality of pieces of image data indicating a plurality of images that are combined to form an information image, and performing a control of projecting the plurality of images from the projection apparatus at different timings.

According to the present invention, a control device, a control method, and a computer readable medium storing a control program that can deliver information based on projection and capturing of an image with high accuracy even in a circumstance in which it is difficult to perform high accuracy projection and imaging can be provided.

### BRIEF DESCRIPTION OF THE DRAWINGS

FIG. 1 is a diagram illustrating an example of a moving object 10 to which a control device according to an embodiment of the present invention can be applied.

FIG. 2 is a diagram illustrating an example of a configuration of the moving object 10.

FIG. 3 is a schematic diagram illustrating an example of an internal configuration of a projection apparatus 11.

FIG. 4 is a diagram illustrating an example of a hardware configuration of an information reading apparatus 80.

FIG. 5 is a sequence diagram illustrating a first example of information delivery under a second control of a control device 14.

FIG. 6 is a diagram (Part 1) for describing each operation of the information delivery illustrated in FIG. 5.

FIG. 7 is a diagram (Part 2) for describing each operation of the information delivery illustrated in FIG. 5.

FIG. 8 is a diagram (Part 3) for describing each operation of the information delivery illustrated in FIG. 5.

FIG. 9 is a diagram (Part 4) for describing each operation of the information delivery illustrated in FIG. 5.

FIG. 10 is a diagram (Part 5) for describing each operation of the information delivery illustrated in FIG. 5.

FIG. 11 is a diagram (Part 6) for describing each operation of the information delivery illustrated in FIG. 5.

FIG. 12 is a diagram (Part 7) for describing each operation of the information delivery illustrated in FIG. 5.

FIG. 13 is a diagram (Part 8) for describing each operation of the information delivery illustrated in FIG. 5.

FIG. 14 is a diagram illustrating an example of deterioration of a two-dimensional code 50 in long range projection under a first control.

FIG. 15 is a diagram illustrating an example of measurement of a distance d between the projection apparatus 11 and a projection destination object 6.

FIG. 16 is a flowchart illustrating an example of processing of the control device 14 based on the distance d between the projection apparatus 11 and the projection destination object 6.

FIG. 17 is a flowchart illustrating another example of the processing of the control device 14 based on the distance d between the projection apparatus 11 and the projection destination object 6.

FIG. 18 is a flowchart illustrating still another example of the processing of the control device 14 based on the distance d between the projection apparatus 11 and the projection destination object 6.

FIG. 19 is a sequence diagram illustrating a second example of the information delivery under the second control of the control device 14.

FIG. 20 is a diagram (Part 1) for describing each operation of the information delivery illustrated in FIG. 19.

FIG. 21 is a diagram (Part 2) for describing each operation of the information delivery illustrated in FIG. 19.

FIG. 22 is a diagram (Part 3) for describing each operation of the information delivery illustrated in FIG. 19.

FIG. 23 is a diagram (Part 4) for describing each operation of the information delivery illustrated in FIG. 19.

FIG. 24 is a diagram (Part 5) for describing each operation of the information delivery illustrated in FIG. 19.

FIG. 25 is a diagram (Part 6) for describing each operation of the information delivery illustrated in FIG. 19.

FIG. 26 is a diagram (Part 7) for describing each operation of the information delivery illustrated in FIG. 19.

FIG. 27 is a sequence diagram illustrating a third example of the information delivery under the second control of the control device 14.

FIG. 28 is a diagram illustrating an example of a circumstance in which a projection range is limited by an obstacle between the moving object 10 and the projection destination object 6.

FIG. 29 is a sequence diagram illustrating a fourth example of the information delivery under the second control of the control device 14.

FIG. 30 is a sequence diagram illustrating a fifth example of the information delivery under the second control of the control device 14.

FIG. 31 is a diagram illustrating an example of a control device 110 to which the control device according to the embodiment of the present invention is applied.

FIG. 32 is a diagram illustrating an example of a hardware configuration of the control device 110.

### DESCRIPTION OF THE PREFERRED EMBODIMENTS

Hereinafter, an example of an embodiment of the present invention will be described with reference to the drawings.

### Embodiment

### Moving Object 10 to Which Control Device According to Present Invention can be Applied

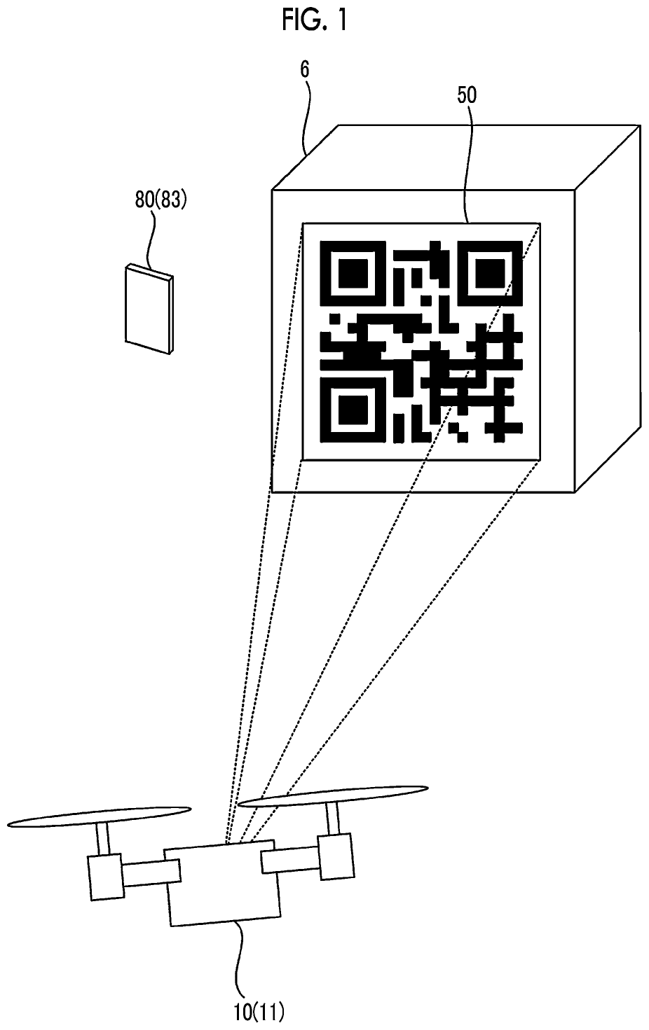

FIG. 1 is a diagram illustrating an example of a moving object 10 to which a control device according to the embodiment of the present invention can be applied. As illustrated in FIG. 1, the moving object 10 is a movable flying object and is, for example, an unmanned aerial vehicle also referred to as a drone. For example, the moving object 10 is a multicopter including three or more rotors (for example, four rotors).

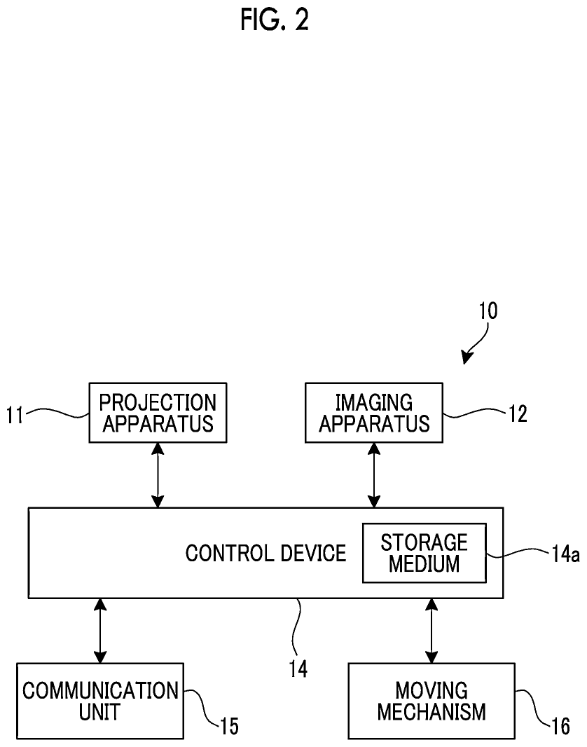

A projection apparatus 11 is mounted on the moving object 10. The projection apparatus 11 is a projection apparatus that can perform projection to a projection destination object 6. The projection apparatus 11 will be described using FIG. 2. The projection destination object 6 is an object such as a wall or a screen having a projection surface on which a projection image can be displayed by the projection apparatus 11. In the example illustrated in FIG. 1, the projection destination object 6 is a rectangular cuboid. The projection apparatus 11 can project the image to the projection destination object 6 while the moving object 10 is flying.

The control device according to the embodiment of the present invention is mounted on, for example, the moving object 10 and controls the projection of the projection apparatus 11. The control device can execute a first control and a second control. The first control is, for example, as illustrated in FIG. 1, a control of projecting a two-dimensional code 50 to the projection destination object 6 from the projection apparatus 11. The two-dimensional code 50 is an example of an information image from which information can be acquired by optically reading the information image. The second control is a control of projecting a plurality of images that are subjected to linking processing to form the two-dimensional code 50 to the projection destination object 6 from the projection apparatus 11 at different timings. A specific example of the second control will be described later. The linking processing is processing of generating one information image by linking the plurality of images to each other and is an example of combining of the plurality of images.

The two-dimensional code 50 is an image of an approximately square shape having a white region and a black region. An arrangement of the white region and the black region in the two-dimensional code 50 represents information such as text information, and the information can be obtained by optically reading the arrangement of the white region and the black region in the two-dimensional code 50.

An information reading apparatus 80 is an information terminal comprising an imaging apparatus 83. The imaging apparatus 83 is an example of an imaging unit that can image the projection destination object 6. The imaging apparatus 83 will be described using FIG. 4. The information reading apparatus 80 may be an information terminal installed at a position at which the projection destination object 6 can be imaged or may be a smartphone or a tablet terminal that can be carried by a user.

### Configuration of Moving Object 10

FIG. 2 is a diagram illustrating an example of a configuration of the moving object 10. As illustrated in FIG. 2, the moving object 10 comprises, for example, the projection apparatus 11, an imaging apparatus 12, a control device 14, a communication unit 15, and a moving mechanism 16.

The projection apparatus 11 is composed of, for example, a liquid crystal projector or a projector using liquid crystal on silicon (LCOS). Hereinafter, the projection apparatus 11 will be described as a liquid crystal projector.

The imaging apparatus 12 is an imaging unit including an imaging lens and an imaging clement. For example, a complementary metal-oxide-semiconductor (CMOS) image sensor can be used as the imaging element.

The control device 14 is an example of the control device according to the embodiment of the present invention. The control device 14 performs various controls in the moving object 10. Examples of the controls of the control device 14 include a control of the projection performed by the projection apparatus 11, a control of imaging performed by the imaging apparatus 12, a control of communication performed by the communication unit 15, and a control of movement of the moving object 10 performed by the moving mechanism 16.

The control device 14 is a device including a control unit composed of various processors, a communication interface (not illustrated) for communicating with each unit, and a storage medium 14a such as a hard disk, a solid state drive (SSD), or a read only memory (ROM) and manages and controls the moving object 10. Examples of the various processors of the control unit of the control device 14 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

A structure of the various processors is more specifically an electric circuit in which circuit elements such as semiconductor elements are combined. The control unit of the control device 14 may be composed of one of the various processors or may be composed of a combination of two or more processors of the same type or different types (for example, a combination of a plurality of FPGAs or a combination of a CPU and an FPGA).

The communication unit 15 is a communication interface through which communication can be performed with other apparatuses. For example, the communication unit 15 is a wireless communication interface through which the moving object 10 performs wireless communication with an information terminal on the ground while the moving object 10 is flying.

The moving mechanism 16 is a mechanism for moving the moving object 10. For example, in a case where the moving object 10 is a multicopter, the moving mechanism 16 includes four rotors, each actuator such as a motor that rotates each of the rotors, and a control circuit that controls each actuator. However, the number of rotors or the like included in the moving mechanism 16 may be three or may be five or more.

The projection apparatus 11, the imaging apparatus 12, the control device 14, the communication unit 15, and the moving mechanism 16 are implemented as, for example, one apparatus. Alternatively, the projection apparatus 11, the imaging apparatus 12, the control device 14, the communication unit 15, and the moving mechanism 16 may be implemented by a plurality of apparatuses that can cooperate by communicating with each other.

### Internal Configuration of Projection Apparatus 11

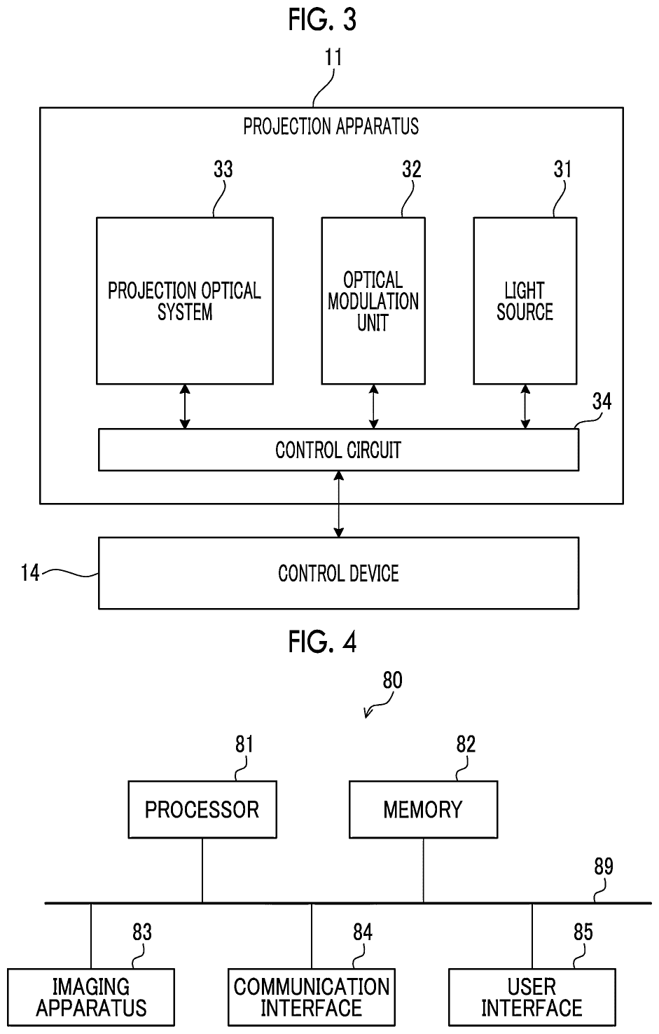

FIG. 3 is a schematic diagram illustrating an example of an internal configuration of the projection apparatus 11. The projection apparatus 11 of the moving object 10 illustrated in FIG. 2 comprises a light source 31, an optical modulation unit 32, a projection optical system 33, and a control circuit 34, as illustrated in FIG. 3. The light source 31 includes a light emitting element such as a laser or a light emitting diode (LED) and emits, for example, white light.

The optical modulation unit 32 is composed of three liquid crystal panels (optical modulation elements) that emit each color image by modulating each color light which is emitted from the light source 31 and which is separated into three colors of red, blue, and green by a color separation mechanism, not illustrated, based on image information, and a dichroic prism that mixes each color image emitted from the three liquid crystal panels and that emits the mixed color image in the same direction. Each color image may be emitted by mounting filters of red, blue, and green in the three liquid crystal panels, respectively, and modulating the white light emitted from the light source 31 using each liquid crystal panel.

The light from the light source 31 and the optical modulation unit 32 is incident on the projection optical system 33. The projection optical system 33 includes at least one lens and is composed of, for example, a relay optical system. The light that has passed through the projection optical system 33 is projected to the projection destination object 6.

A region irradiated with the light transmitted through the entire range of the optical modulation unit 32 on the projection destination object 6 is the projectable range to which the projection can be performed by the projection apparatus 11. A region with which the light actually transmitted from the optical modulation unit 32 is irradiated in the projectable range is a projection range of the projection apparatus 11. For example, a size, a position, and a shape of the projection range of the projection apparatus 11 are changed in the projectable range by controlling a size, a position, and a shape of a region through which the light is transmitted in the optical modulation unit 32.

The control circuit 34 projects an image based on display data input from the control device 14 to the projection destination object 6 by controlling the light source 31, the optical modulation unit 32, and the projection optical system 33 based on the display data. The display data input into the control circuit 34 is composed of three pieces of data including red display data, blue display data, and green display data.

In addition, the control circuit 34 enlarges or reduces the projection range of the projection apparatus 11 by changing the projection optical system 33 based on an instruction input from the control device 14. In addition, the control circuit 34 may move the projection range of the projection apparatus 11 by changing the projection optical system 33 based on an instruction input from the control device 14.

In addition, the projection apparatus 11 comprises a shift mechanism that mechanically or optically moves the projection range of the projection apparatus 11 while maintaining an image circle of the projection optical system 33. The image circle of the projection optical system 33 is a region in which the projection light incident on the projection optical system 33 correctly passes through the projection optical system 33 in terms of light fall-off, color separation, edge part curvature, and the like.

The shift mechanism is implemented by at least any of an optical system shift mechanism that performs optical system shifting or an electronic shift mechanism that performs electronic shifting.

The optical system shift mechanism is, for example, a mechanism that moves the projection optical system 33 in a direction perpendicular to an optical axis or a mechanism that moves the optical modulation unit 32 in the direction perpendicular to the optical axis instead of moving the projection optical system 33. In addition, the optical system shift mechanism may move the projection optical system 33 and move the optical modulation unit 32 in combination with each other.

The electronic shift mechanism is a mechanism that performs pseudo shifting of the projection range by changing a range through which the light is transmitted in the optical modulation unit 32.

In addition, the projection apparatus 11 may comprise a projection direction changing mechanism that moves the image circle of the projection optical system 33 and the projection range. The projection direction changing mechanism is a mechanism that changes a projection direction of the projection apparatus 11 by mechanically rotating to change a direction of the projection apparatus 11.

### Hardware Configuration of Information Reading Apparatus 80

FIG. 4 is a diagram illustrating an example of a hardware configuration of the information reading apparatus 80. The information reading apparatus 80 illustrated in FIG. 1 comprises, for example, as illustrated in FIG. 4, a processor 81, a memory 82, the imaging apparatus 83, a communication interface 84, and a user interface 85. The processor 81, the memory 82, the imaging apparatus 83, the communication interface 84, and the user interface 85 are connected to each other through, for example, a bus 89.

The processor 81 is a circuit that performs signal processing and is, for example, a CPU that controls the entire information reading apparatus 80. The processor 81 may be implemented by other digital circuits such as an FPGA and a digital signal processor (DSP). In addition, the processor 81 may be implemented by combining a plurality of digital circuits with each other.

The memory 82 includes, for example, a main memory and an auxiliary memory. The main memory is, for example, a random access memory (RAM). The main memory is used as a work area of the processor 81.

The auxiliary memory is, for example, a non-volatile memory such as a magnetic disk, an optical disc, or a flash memory. The auxiliary memory stores various programs for operating the information reading apparatus 80. The programs stored in the auxiliary memory are loaded into the main memory and executed by the processor 81.

In addition, the auxiliary memory may include a portable memory that can be detached from the information reading apparatus 80. Examples of the portable memory include a memory card such as a universal serial bus (USB) flash drive or a secure digital (SD) memory card, and an external hard disk drive.

The imaging apparatus 83 is an imaging unit including an imaging lens and an imaging element. For example, a CMOS image sensor can be used as the imaging element.

The communication interface 84 is a communication interface for performing wireless communication with an apparatus (for example, the moving object 10) outside the information reading apparatus 80. The communication interface 84 is controlled by the processor 81.

The user interface 85 includes, for example, an input device that receives an operation input from the user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 85 is controlled by the processor 81.

### First Example of Information Delivery Under Second Control of Control Device 14

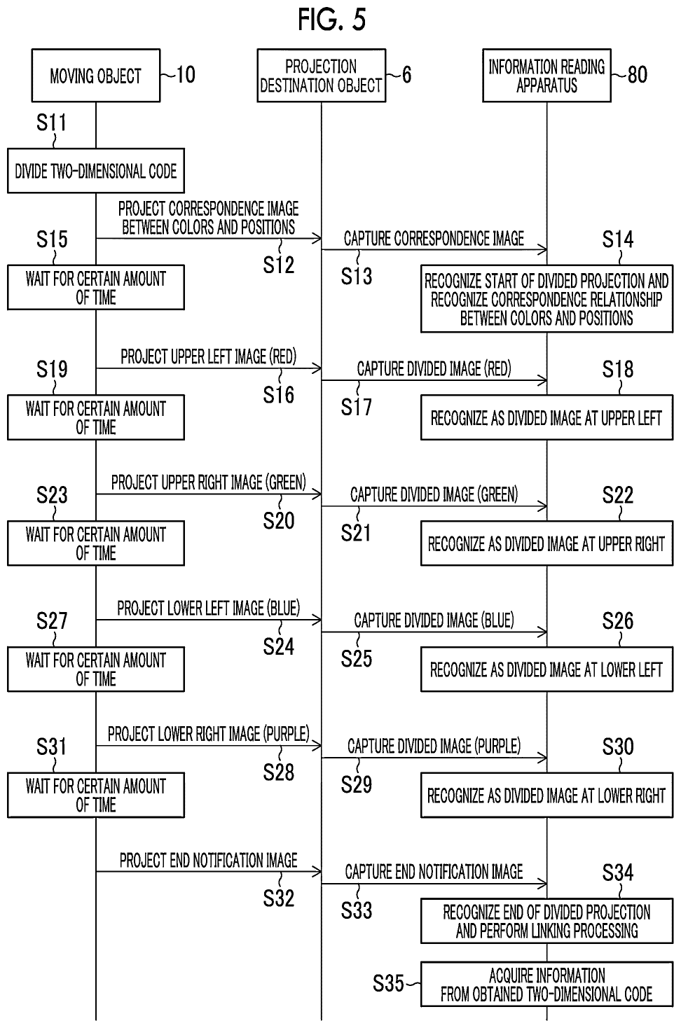

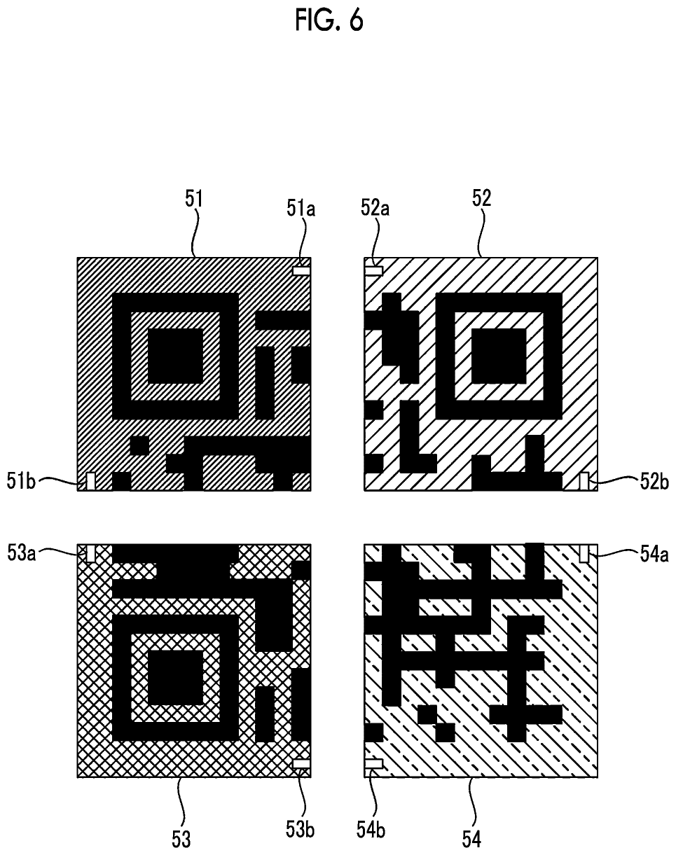

FIG. 5 is a sequence diagram illustrating a first example of information delivery under the second control of the control device 14. In a case where the control device 14 mounted on the moving object 10 executes the second control, the moving object 10 and the information reading apparatus 80, for example, operate as illustrated in FIG. 5. The operation of the moving object 10 illustrated in FIG. 5 is executed by the control device 14 mounted on the moving object 10. FIGS. 6 to 13 are diagrams for describing each operation of the information delivery illustrated in FIG. 5.

As illustrated in FIG. 5, first, the moving object 10 divides the two-dimensional code 50 (step S11). For example, the moving object 10 generates each image data indicating an upper left image 51, an upper right image 52, a lower left image 53, and a lower right image 54 illustrated in FIG. 6 based on two-dimensional code data indicating the two-dimensional code 50 illustrated in FIG. 1. The upper left image 51, the upper right image 52, the lower left image 53, and the lower right image 54 are images obtained by dividing the two-dimensional code 50 into four parts. That is, the upper left image 51, the upper right image 52, the lower left image 53, and the lower right image 54 are the plurality of images which are subjected to the linking processing to form the two-dimensional code 50.

In addition, as illustrated in FIG. 6, the moving object 10 may provide the upper left image 51, the upper right image 52, the lower left image 53, and the lower right image 54 as images of colors different from each other. In the example in FIG. 6, for example, the upper left image 51 is an image of a red color, the upper right image 52 is an image of a green color, the lower left image 53 is an image of a blue color, and the lower right image 54 is an image of a purple color.

The upper left image 51 being the image of the red color means, for example, as in the example in FIG. 6, a state where a part of a white color in the upper left image 51 obtained by dividing the two-dimensional code 50 is set to have the red color. Alternatively, the upper left image 51 being the image of the red color may mean a state where a part of a black color in the upper left image 51 obtained by dividing the two-dimensional code 50 is set to have the red color. Alternatively, the upper left image 51 being the image of the red color may mean a state where the part of the white color and the part of the black color in the upper left image 51 obtained by dividing the two-dimensional code 50 are set to have red colors different from each other (for example, bright red and dark red). While the color of the upper left image 51 has been described, the same also applies to the upper right image 52, the lower left image 53, and the lower right image 54.

In this example, it is assumed that the upper left image 51, the upper right image 52, the lower left image 53, and the lower right image 54 are images obtained by setting a white part in the two-dimensional code 50 to the red color, the green color, the blue color, and the purple color, respectively.

In addition, as illustrated in FIG. 5, the moving object 10 may attach alignment marks 51a and 51b, alignment marks 52a and 52b, alignment marks 53a and 53b, and alignment marks 54a and 54b to the upper left image 51, the upper right image 52, the lower left image 53, and the lower right image 54, respectively. The alignment marks 51a, 51b, 52a, 52b, 53a, 53b, 54a, and 54b are examples of a registration image indicating a positional relationship among the upper left image 51, the upper right image 52, the lower left image 53, and the lower right image 54 in the linking processing.

For example, by linking the upper left image 51 and the upper right image 52 to each other such that positions of the alignment mark 51a of the upper left image 51 and the alignment mark 52a of the upper right image 52 in a vertical direction match, the upper left image 51 and the upper right image 52 can be linked to each other in a state where positions of the upper left image 51 and the upper right image 52 in the vertical direction match.

In addition, by linking the upper left image 51 and the lower left image 53 to each other such that positions of the alignment mark 51b of the upper left image 51 and the alignment mark 53a of the lower left image 53 in a horizontal direction match, the upper left image 51 and the lower left image 53 can be linked to each other in a state where positions of the upper left image 51 and the lower left image 53 in the horizontal direction match.

In addition, by linking the upper right image 52 and the lower right image 54 to each other such that positions of the alignment mark 52b of the upper right image 52 and the alignment mark 54a of the lower right image 54 in the horizontal direction match, the upper right image 52 and the lower right image 54 can be linked to each other in a state where positions of the upper right image 52 and the lower right image 54 in the horizontal direction match.

In addition, by linking the lower left image 53 and the lower right image 54 to each other such that positions of the alignment mark 53b of the lower left image 53 and the alignment mark 54b of the lower right image 54 in the vertical direction match, the lower left image 53 and the lower right image 54 can be linked to each other in a state where positions of the lower left image 53 and the lower right image 54 in the vertical direction match.

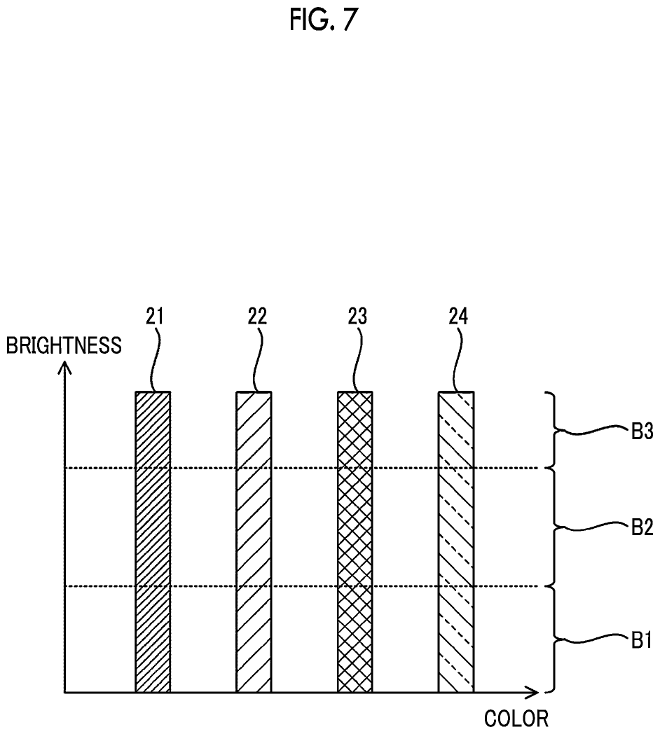

FIG. 7 illustrates an example of color components of the projection image of the projection apparatus 11. In FIG. 7, a horizontal direction denotes a color (wavelength) of the projection image of the projection apparatus 11, and a vertical axis denotes a pixel value of the projection image of the projection apparatus 11. A red color component 21 is a component of a red color part of the upper left image 51. A green color component 22 is a component of a green color part of the upper right image 52. A blue color component 23 is a component of a blue color part of the lower left image 53. A purple color component 24 is a component of a purple color part of the lower right image 54.

A brightness region B1 is a region that is not detected (ignored) in the optical reading of the information reading apparatus 80. A brightness region B3 is a brightness region of the red color component 21, the green color component 22, the blue color component 23, and the purple color component 24. For example, the alignment marks 51a, 51b, 52a, 52b, 53a, 53b, 54a, and 54b can be set as gray images in a brightness region B2 between the brightness region B1 and the brightness region B3. Accordingly, it is easy to obtain an image equivalent to the two-dimensional code 50 by removing the alignment marks 51a, 51b, 52a, 52b, 53a, 53b, 54a, and 54b after the linking processing of the upper left image 51, the upper right image 52, the lower left image 53, and the lower right image 54.

FIG. 5 will be referred to again for description. Next, the moving object 10 projects a correspondence image indicating a correspondence relationship between each color of the upper left image 51, the upper right image 52, the lower left image 53, and the lower right image 54 obtained by the division in step S11 and each position of the upper left image 51, the upper right image 52, the lower left image 53, and the lower right image 54 in the linking processing to the projection destination object 6 from the projection apparatus 11 (step S12).

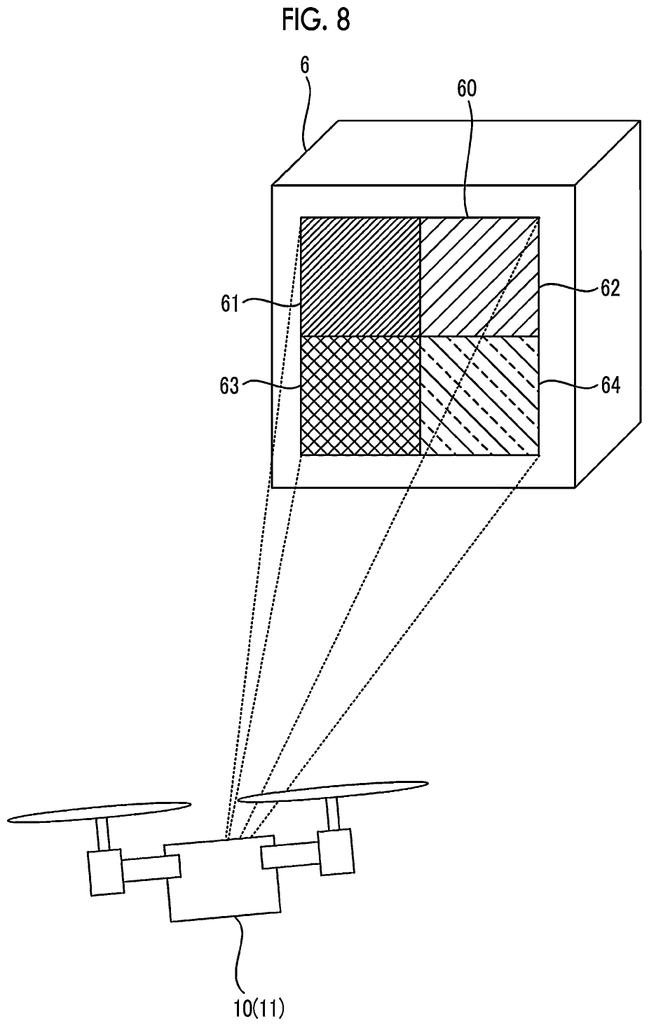

For example, the moving object 10 projects a correspondence image 60 illustrated in FIG. 8 to the projection destination object 6 from the projection apparatus 11 as the correspondence image between the colors and the positions. The correspondence image 60 is an image of an approximately square shape having an upper left region 61, an upper right region 62, a lower left region 63, and a lower right region 64. Positions of the upper left region 61, the upper right region 62, the lower left region 63, and the lower right region 64 in the correspondence image 60 correspond to the positions of the upper left image 51, the upper right image 52, the lower left image 53, and the lower right image 54 in the two-dimensional code 50, respectively.

In addition, colors of the upper left region 61, the upper right region 62, the lower left region 63, and the lower right region 64 in the correspondence image 60 are set to the red color, the green color, the blue color, and the purple color, respectively, in accordance with the colors of the upper left image 51, the upper right image 52, the lower left image 53, and the lower right image 54 in the two-dimensional code 50. Accordingly, by optically reading the correspondence image 60 via the imaging apparatus 83, the information reading apparatus 80 can recognize the correspondence relationship indicating that the image of the red color is at the upper left, the image of the green color is at the upper right, the image of the blue color is at the lower left, and the image of the purple color is at the lower right.

In addition, in this example, the correspondence image 60 also serves as notification information for providing notification of a start of divided display of the two-dimensional code 50 (second control) to the information reading apparatus 80. For example, the information reading apparatus 80 is configured to recognize that the divided display of the two-dimensional code 50 has started in a case where an image such as the correspondence image 60 in which a plurality of images having different colors are arranged in a tiled manner is captured. Alternatively, a predetermined marker image or the like for providing the notification of the start of the divided display of the two-dimensional code 50 (second control) may be included in the correspondence image 60, and the information reading apparatus 80 may be configured to recognize that the divided display of the two-dimensional code 50 has started in a case where the predetermined marker image or the like is captured.

FIG. 5 will be referred to again for description. Next, the information reading apparatus 80 captures the correspondence image 60 projected to the projection destination object 6 (step S13). Next, the information reading apparatus 80 recognizes the start of the divided display of the two-dimensional code 50 (second control) and recognizes the correspondence relationship between the colors and the positions based on an imaging result of the correspondence image 60 (step S14). In the example of the correspondence image 60 in FIG. 8, the information reading apparatus 80 recognizes the correspondence relationship indicating that the image of the red color is at the upper left, the image of the green color is at the upper right, the image of the blue color is at the lower left, and the image of the purple color is at the lower right.

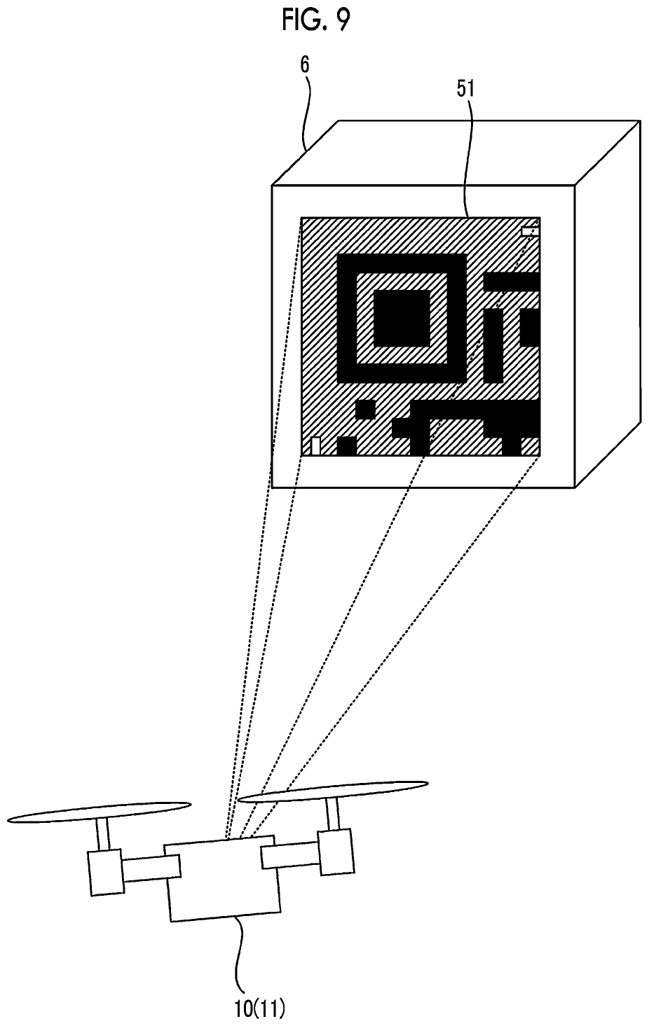

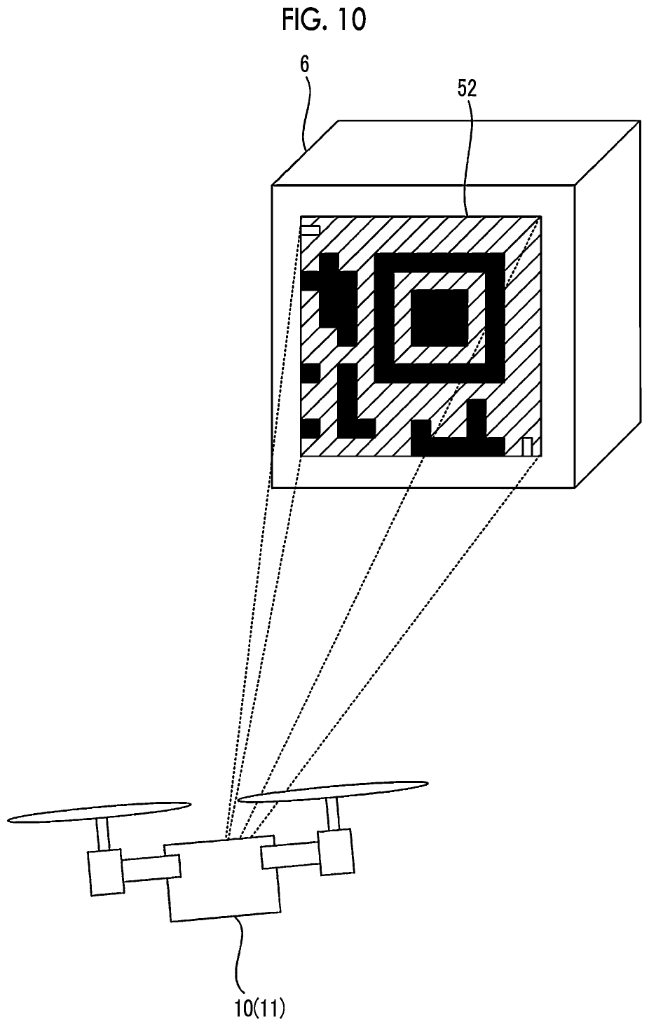

Meanwhile, the moving object 10 waits for a certain amount of time from step S12 (step S15), and enlarges the upper left image 51 of the red color among the divided images obtained by the division in step S11 and projects the upper left image 51 to the projection destination object 6 from the projection apparatus 11 (step S16). For example, as illustrated in FIG. 9, the moving object 10 enlarges the upper left image 51 to have the same size as the two-dimensional code 50 illustrated in FIG. 1 and projects the upper left image 51 to the projection destination object 6.

Next, the information reading apparatus 80 captures the upper left image 51 projected to the projection destination object 6 (step S17). Next, the information reading apparatus 80 recognizes the upper left image 51 as the divided image at the upper left based on the correspondence relationship between the colors and the positions recognized in step S14 because the upper left image 51 captured in step S17 has the red color (step S18).

Meanwhile, the moving object 10 waits for a certain amount of time from step S15 (step S19), and enlarges the upper right image 52 of the green color among the divided images obtained by the division in step S11 and projects the upper right image 52 to the projection destination object 6 from the projection apparatus 11 (step S20). For example, as illustrated in FIG. 10, the moving object 10 enlarges the upper right image 52 to have the same size as the two-dimensional code 50 illustrated in FIG. 1 and projects the upper right image 52 to the projection destination object 6.

Next, the information reading apparatus 80 captures the upper right image 52 projected to the projection destination object 6 (step S21). Next, the information reading apparatus 80 recognizes the upper right image 52 as the divided image at the upper right based on the correspondence relationship between the colors and the positions recognized in step S14 because the upper right image 52 captured in step S21 has the green color (step S22).

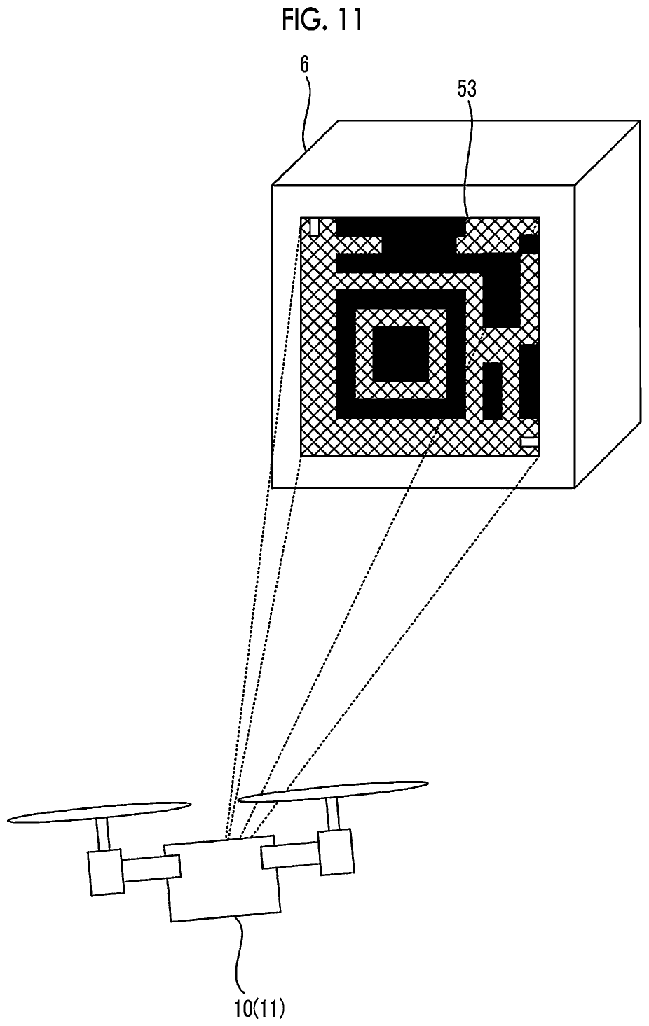

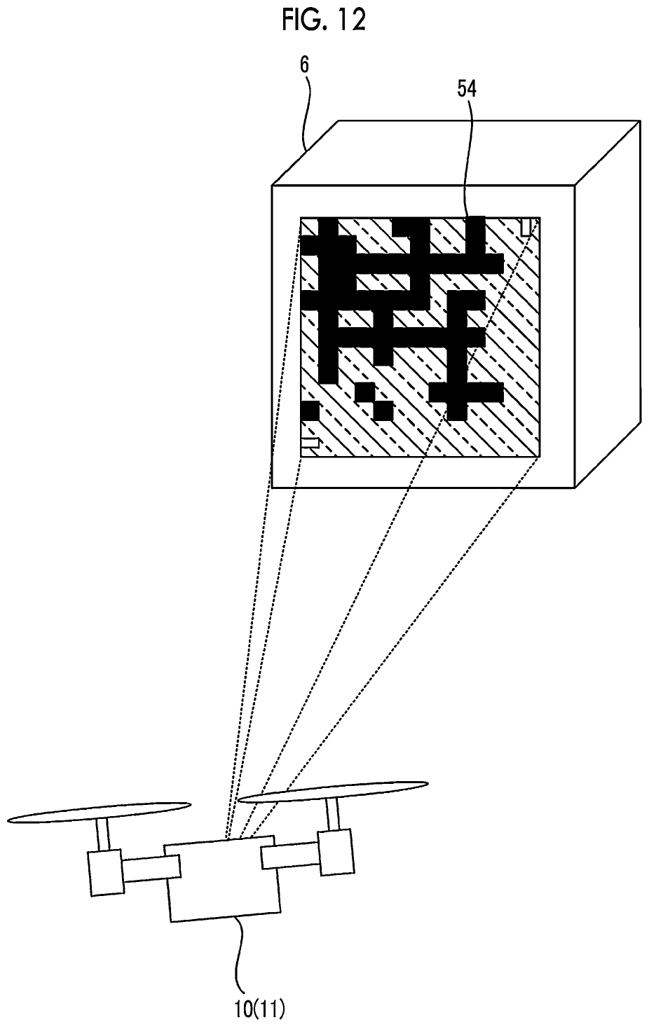

Meanwhile, the moving object 10 waits for a certain amount of time from step S19 (step S23), and enlarges the lower left image 53 of the blue color among the divided images obtained by the division in step S11 and projects the lower left image 53 to the projection destination object 6 from the projection apparatus 11 (step S24). For example, as illustrated in FIG. 11, the moving object 10 enlarges the lower left image 53 to have the same size as the two-dimensional code 50 illustrated in FIG. 1 and projects the lower left image 53 to the projection destination object 6.

Next, the information reading apparatus 80 captures the lower left image 53 projected to the projection destination object 6 (step S25). Next, the information reading apparatus 80 recognizes the lower left image 53 as the divided image at the lower left based on the correspondence relationship between the colors and the positions recognized in step S14 because the lower left image 53 captured in step S25 has the blue color (step S26).

Meanwhile, the moving object 10 waits for a certain amount of time from step S23 (step S27), and enlarges the lower right image 54 of the purple color among the divided images obtained by the division in step S11 and projects the lower right image 54 to the projection destination object 6 from the projection apparatus 11 (step S28). For example, as illustrated in FIG. 12, the moving object 10 enlarges the lower right image 54 to have the same size as the two-dimensional code 50 illustrated in FIG. 1 and projects the lower right image 54 to the projection destination object 6.

Next, the information reading apparatus 80 captures the lower right image 54 projected to the projection destination object 6 (step S29). Next, the information reading apparatus 80 recognizes the lower right image 54 as the divided image at the lower right based on the correspondence relationship between the colors and the positions recognized in step S14 because the lower right image 54 captured in step S29 has the purple color (step S30).

Meanwhile, the moving object 10 waits for a certain amount of time from step S27 (step S31) and projects an end notification image for providing notification of an end of the divided display of the two-dimensional code 50 (second control) to the projection destination object 6 from the projection apparatus 11 (step S32).

The end notification image is, for example, the same image as the correspondence image 60 projected in step S12. For example, the information reading apparatus 80 is configured to recognize the end of the divided display of the two-dimensional code 50 in a case where the projection of the correspondence image 60 for the second time is detected. Alternatively, the end notification image may be a predetermined marker image or the like for providing the notification of the end of the divided display of the two-dimensional code 50 (second control), and the information reading apparatus 80 may be configured to recognize the end of the divided display of the two-dimensional code 50 in a case where the predetermined marker image or the like is captured.

Next, the information reading apparatus 80 captures the end notification image projected to the projection destination object 6 (step S33). Next, the information reading apparatus 80 recognizes the end of the divided display and performs the linking processing of the upper left image 51, the upper right image 52, the lower left image 53, and the lower right image 54 obtained by capturing (step S34).

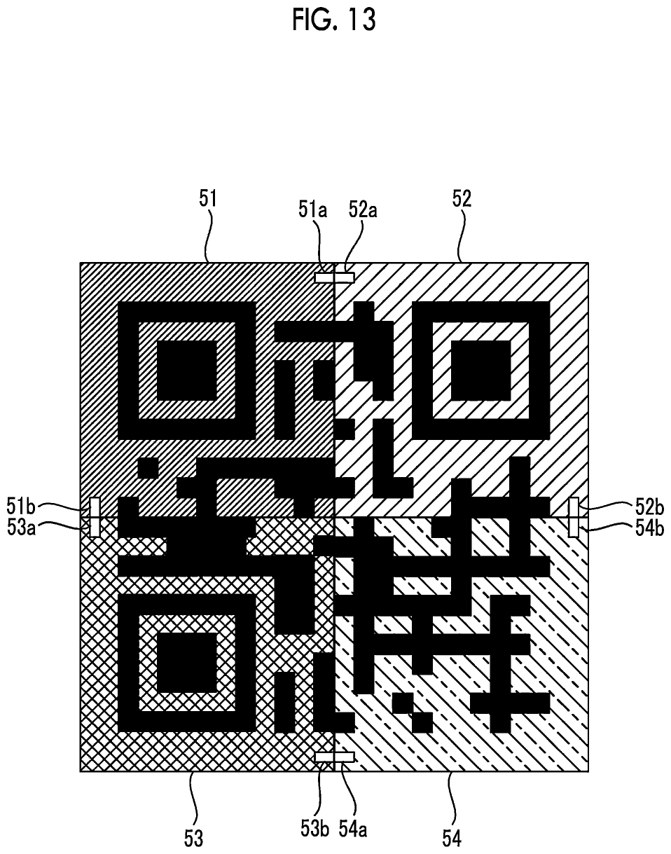

For example, the information reading apparatus 80 performs the linking processing as illustrated in FIG. 13. Specifically, the information reading apparatus 80 arranges the upper left image 51, the upper right image 52, the lower left image 53, and the lower right image 54 at the upper left, the upper right, the lower left, and the lower right, respectively, based on recognition results in steps S18, S22, S26, and S30. In addition, the information reading apparatus 80 finely adjusts a relative position of each of the upper left image 51, the upper right image 52, the lower left image 53, and the lower right image 54 using the alignment marks 51a, 51b, 52a, 52b, 53a, 53b, 54a, and 54b. This results in the state illustrated in FIG. 13.

In addition, the information reading apparatus 80 performs processing of restoring each color of the upper left image 51, the upper right image 52, the lower left image 53, and the lower right image 54 to the original white color and the original black color. For example, the information reading apparatus 80 performs processing of converting a region of the red color in the upper left image 51 to have the white color. In addition, the information reading apparatus 80 performs processing of removing the alignment marks 51a, 51b, 52a, 52b, 53a, 53b, 54a, and 54b. For example, the information reading apparatus 80 performs processing of converting regions of the alignment marks 51a, 51b, 52a, 52b, 53a, 53b, 54a, and 54b to have the white color.

Accordingly, the information reading apparatus 80 can obtain two-dimensional code data indicating a two-dimensional code equivalent to the two-dimensional code 50 illustrated in FIG. 1. FIG. 5 will be referred to again for description. Next, the information reading apparatus 80 acquires information from the two-dimensional code data indicating the two-dimensional code obtained through the linking processing (step S35) and finishes the series of processing. Accordingly, information equivalent to that in the first control can be delivered to the information reading apparatus 80 from the moving object 10.

The information reading apparatus 80 may be configured to recognize the end of the divided display of the two-dimensional code 50 by recognizing the number of divisions (in this example, four) of the divided display in step S14 and capturing divided images corresponding to the recognized number of divisions. In this case, steps S31 to S33 may be omitted in the processing.

As described above, the control device 14 performs a control of projecting the plurality of images (for example, the upper left image 51, the upper right image 52, the lower left image 53, and the lower right image 54) which are subjected to the linking processing (combined) to form the information image (for example, the image equivalent to the two-dimensional code 50) from the projection apparatus 11 at different timings. Accordingly, even in a circumstance in which it is difficult to perform high accuracy projection and imaging, information delivery based on projection and capturing of the image can be performed with high accuracy.

Examples of the circumstance in which it is difficult to perform high accuracy projection and imaging include a circumstance in which a distance between the moving object 10 (projection apparatus 11) and the projection destination object 6 is long, a circumstance in which it is difficult to project the image with a high contrast because the projection surface of the projection destination object 6 is bright, a circumstance in which a projected image is likely to blur because the moving object 10 shakes significantly, a circumstance in which the captured image is likely to blur because of a long exposure time in the imaging of the imaging apparatus 83 of the information reading apparatus 80, a circumstance in which there is a large amount of noise because of a high ISO sensitivity in the imaging of the imaging apparatus 83 of the information reading apparatus 80, and a circumstance in which defocus blurriness is likely to occur because of a small depth of field in the imaging of the imaging apparatus 83 of the information reading apparatus 80.

In addition, the control device 14 sets the plurality of images which are subjected to the linking processing to form the information image as images of colors different from each other and performs a control of projecting the plurality of images and the correspondence image 60 indicating the correspondence relationship between the colors of the plurality of images and the positions of the plurality of images in the linking processing from the projection apparatus 11 at different timings. Accordingly, the correspondence relationship can be delivered to the information reading apparatus 80 from the control device 14 without performing communication in advance between the control device 14 and the information reading apparatus 80.

In addition, the control device 14 may include the registration image (for example, the alignment marks 51a, 51b, 52a, 52b, 53a, 53b, 54a, and 54b) in the plurality of images which are subjected to the linking processing to form the information image. Accordingly, the linking processing can be performed with higher accuracy in the information reading apparatus 80.

### Deterioration of Two-Dimensional Code 50 in Long Range Projection Under First Control

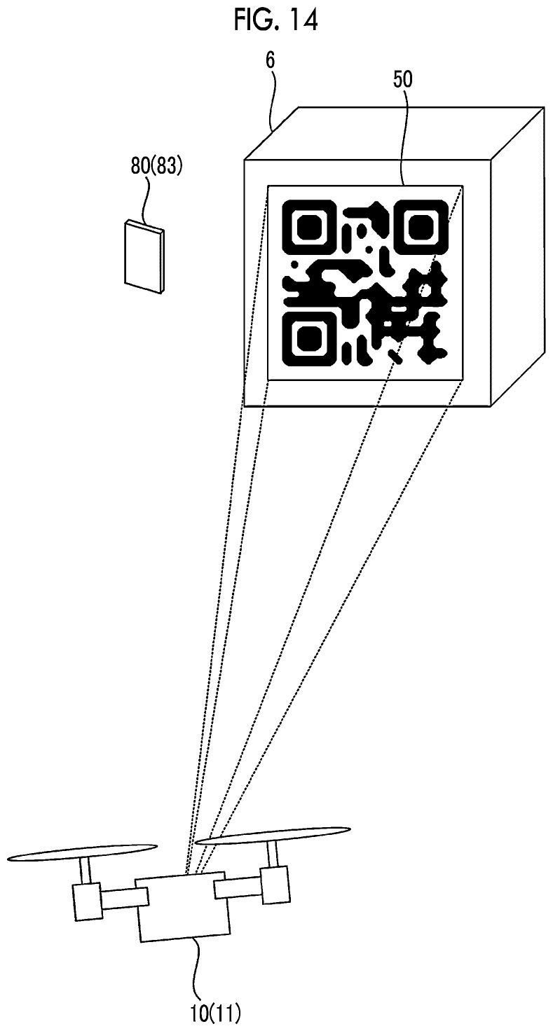

FIG. 14 is a diagram illustrating an example of deterioration of the two-dimensional code 50 in long range projection under the first control. For example, in the circumstance in which the distance between the projection apparatus 11 (moving object 10) and the projection destination object 6 is long, projecting the two-dimensional code 50 to the projection destination object 6 from the projection apparatus 11 under the first control may cause the two-dimensional code 50 projected to the projection destination object 6 to significantly deteriorate because of an effect of telephoto performance of the projection optical system 33, shaking, a heat haze, or the like. In this case, the information reading apparatus 80 may not be able to acquire information from the two-dimensional code 50 even in a case where the two-dimensional code 50 is imaged by the information reading apparatus 80.

### Measurement of Distance d Between Projection Apparatus 11 and Projection Destination Object 6

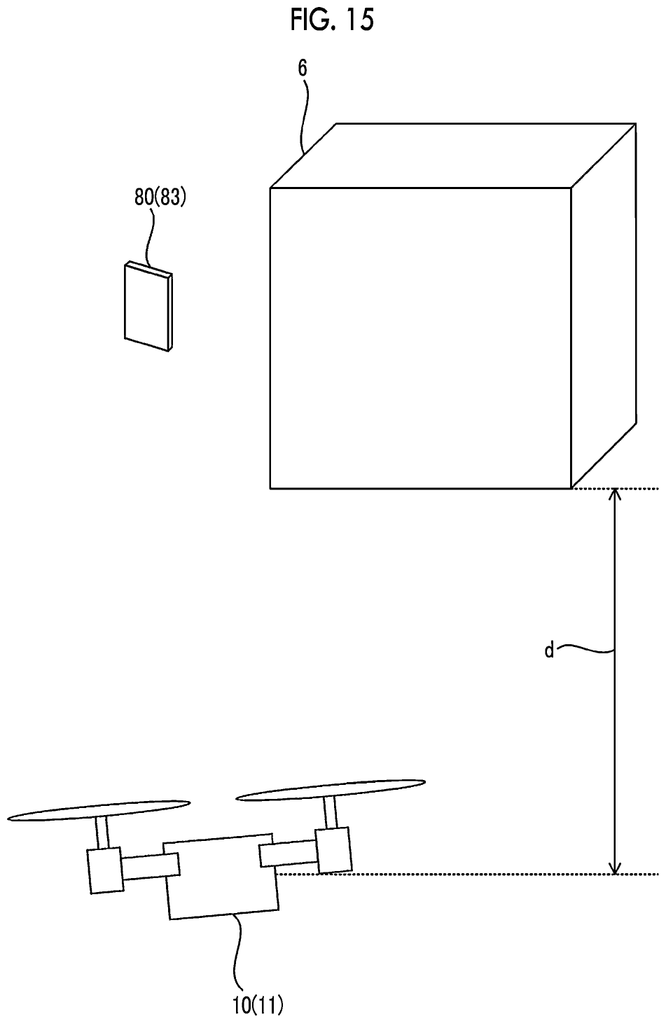

FIG. 15 is a diagram illustrating an example of measurement of a distance d between the projection apparatus 11 and the projection destination object 6. The control device 14 mounted on the moving object 10 measures the distance d between the projection apparatus 11 (moving object 10) and the projection destination object 6.

For example, the control device 14 measures the distance d using a distance measurement unit comprised in the imaging apparatus 12 for auto focus (AF) or the like. The distance measurement unit may be a distance measurement unit of a phase difference detection type or a distance measurement unit of a contrast type. Alternatively, the control device 14 may measure the distance d using a distance measurement device based on time of flight (TOF) or the like mounted on the moving object 10. Alternatively, the control device 14 may measure the distance d using image recognition based on imaging data obtained by the imaging apparatus 12.

### Processing of Control Device 14 Based on Distance d Between Projection Apparatus 11 and Projection Destination Object 6

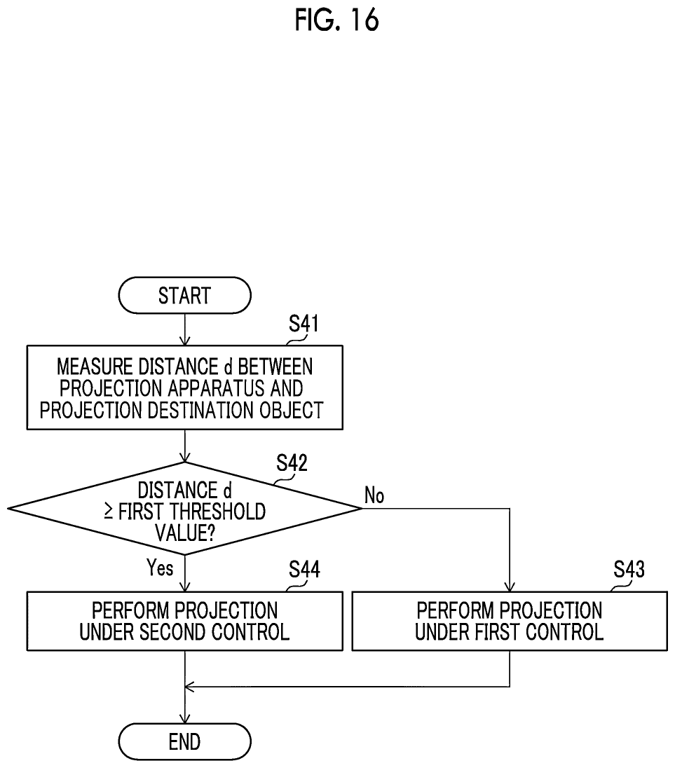

FIG. 16 is a flowchart illustrating an example of processing of the control device 14 based on the distance d between the projection apparatus 11 and the projection destination object 6. The control device 14 executes, for example, processing illustrated in FIG. 16.

First, the control device 14 measures the distance d between the projection apparatus 11 (moving object 10) and the projection destination object 6 (step S41). Next, the control device 14 determines whether or not the distance d measured in step S41 is greater than or equal to a predetermined first threshold value (step S42). The first threshold value is set to be close to the shortest distance d in which it is difficult to deliver information under the first control, by taking, for example, performance of the projection apparatus 11 and the information reading apparatus 80 into consideration.

In step S42, in a case where the distance d is not greater than or equal to the first threshold value (step S42: No), the control device 14, for example, performs the first control illustrated in FIG. 1 (step S43) and finishes the series of processing. That is, the control device 14 performs the first control of projecting the two-dimensional code 50 from the projection apparatus 11.

In step S42, in a case where the distance d is greater than or equal to the first threshold value (step S42: Yes), the control device 14, for example, performs the second control described using FIGS. 5 to 12 (step S44) and finishes the series of processing. That is, the control device 14 performs the second control of sequentially projecting the upper left image 51, the upper right image 52, the lower left image 53, and the lower right image 54 (the plurality of images) from the projection apparatus 11.

As described above, the control device 14 switches between the first control of projecting the two-dimensional code 50 from the projection apparatus 11 and the second control of projecting the upper left image 51, the upper right image 52, the lower left image 53, and the lower right image 54 (the plurality of images) from the projection apparatus 11 at different timings, based on the distance d between the projection apparatus 11 and the projection destination object 6. Accordingly, in a case where high accuracy projection and imaging can be performed because the distance d is short, information can be delivered in a short time under the first control. Even in a case where it is difficult to perform high accuracy projection because the distance d is long, information can be delivered with high accuracy under the second control.

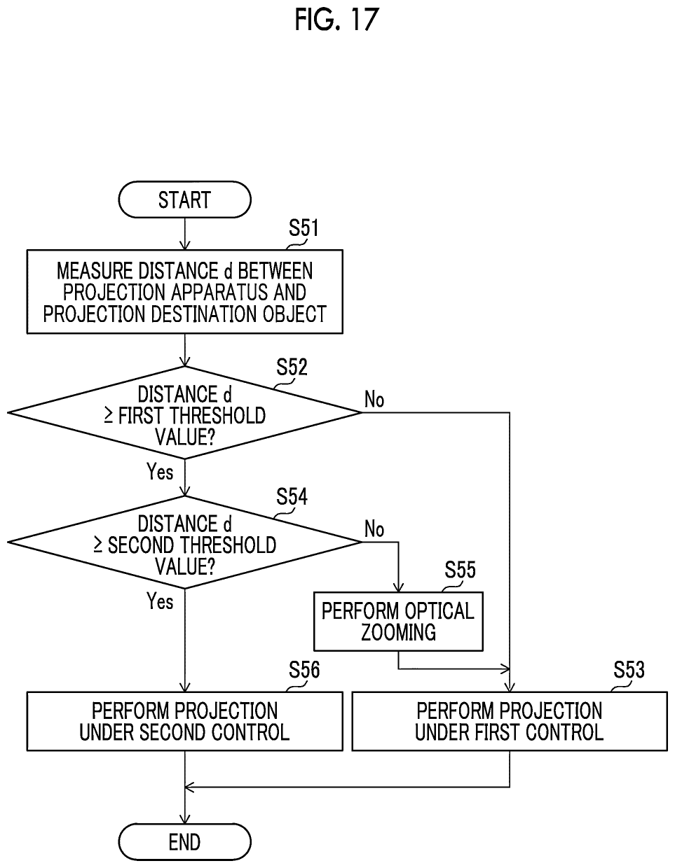

FIG. 17 is a flowchart illustrating another example of the processing of the control device 14 based on the distance d between the projection apparatus 11 and the projection destination object 6. The control device 14 may execute, for example, processing illustrated in FIG. 17.

Steps S51 to S53 illustrated in FIG. 17 are the same as steps S41 to S43 illustrated in FIG. 16. In step S52, in a case where the distance d is greater than or equal to the first threshold value (step S52: Yes), the control device 14 determines whether or not the distance d is greater than or equal to a second threshold value (step S54). Here, the second threshold value is a value greater than the first threshold value. In addition, the second threshold value is set to be close to the longest distance d in which information can be delivered under the first control by performing optical zooming of the projection optical system 33 of the projection apparatus 11, by taking, for example, the performance of the projection apparatus 11 and the information reading apparatus 80 into consideration. In addition, the second threshold value may be dynamically set based on a current optical zooming state (an amount of zooming that can be performed) of the projection optical system 33 of the projection apparatus 11.

In step S54, in a case where the distance d is greater than or equal to the second threshold value (step S54: Yes), the control device 14 transitions to step S56. Step S56 is the same processing as step S44 illustrated in FIG. 16.

In step S54, in a case where the distance d is not greater than or equal to the second threshold value (step S54: No), the control device 14 performs the optical zooming of the projection optical system 33 such that the two-dimensional code 50 can be projected to the projection destination object 6 with a level of quality that enables the information reading apparatus 80 to read the two-dimensional code 50 (step S55), and transitions to step S53.

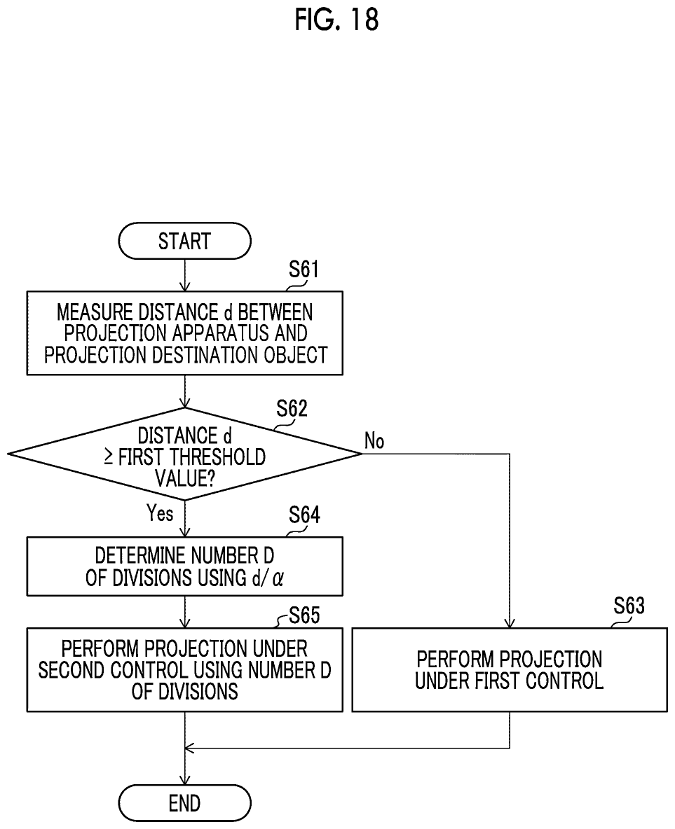

FIG. 18 is a flowchart illustrating still another example of the processing of the control device 14 based on the distance d between the projection apparatus 11 and the projection destination object 6. The control device 14 may execute, for example, processing illustrated in FIG. 18.

Steps S61 to S63 illustrated in FIG. 18 are the same as steps S41 to S43 illustrated in FIG. 16. In step S62, in a case where the distance d is greater than or equal to the first threshold value (step S62: Yes), the control device 14 determines a number D of divisions using an expression d/α (step S64). For example, 4, 9, or 16 is set in the control device 14 as candidates of the number D of divisions, and the control device 14 determines the number of divisions closest to an operation result of d/α from the candidates of the number D of divisions as the number D of divisions. Here, a denotes a predetermined coefficient greater than 1.

Next, the control device 14 transitions to step S65. Step S64 is the same processing as step S44 illustrated in FIG. 16. However, in step S65, the control device 14 performs the projection under the second control using the number D of divisions determined in step S64. The second control using the number D of divisions means performing divided projection by dividing the two-dimensional code 50 into parts of the number D of divisions. For example, the second control described using FIGS. 5 to 12 is a control of performing divided projection by dividing the two-dimensional code 50 into four parts in a matrix of 2×2 and is the second control using the number D of divisions=4.

The second control using the number D of divisions=9 is, for example, a control of performing divided projection by dividing the two-dimensional code 50 into nine parts in a matrix of 3×3. The second control using the number D of divisions=16 is, for example, a control of performing divided projection by dividing the two-dimensional code 50 into 16 parts in a matrix of 4×4. A method of dividing the two-dimensional code 50 is not limited to a matrix, and various division methods can be used. In addition, the number D of divisions is also not limited to 4, 9, 16, or the like and may be 2, 3, or the like.

As described above, the control device 14 may set the number of images (the number D of divisions) to be included in the plurality of images obtained by dividing the two-dimensional code 50 based on the distance d between the projection apparatus 11 and the projection destination object 6. Specifically, the control device 14 increases the number of images (the number of divisions) as the distance d is increased. Accordingly, as it is more likely a circumstance in which it is difficult to perform high accuracy projection because the distance d between the projection apparatus 11 and the projection destination object 6 is long, each divided image can be enlarged to have a large size and be projected. Thus, information can be delivered with high accuracy. In addition, as it is more likely a circumstance in which high accuracy projection can be performed because the distance d between the projection apparatus 11 and the projection destination object 6 is short, the projection can be performed with a small number D of divisions. Thus, information can be delivered in a short time.

### Second Example of Information Delivery Under Second Control of Control Device 14

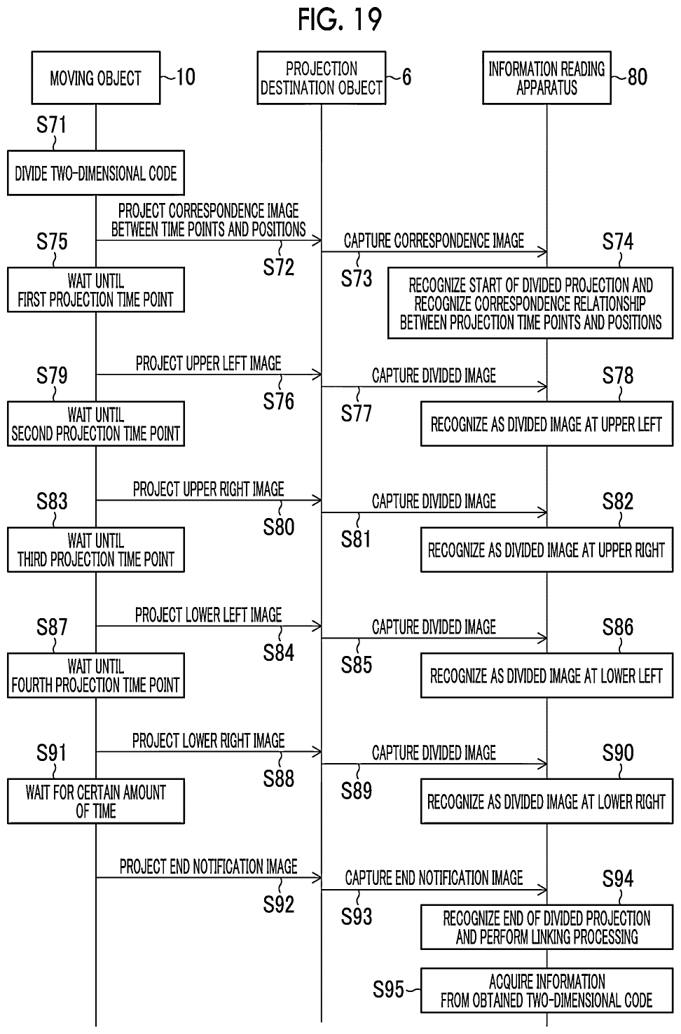

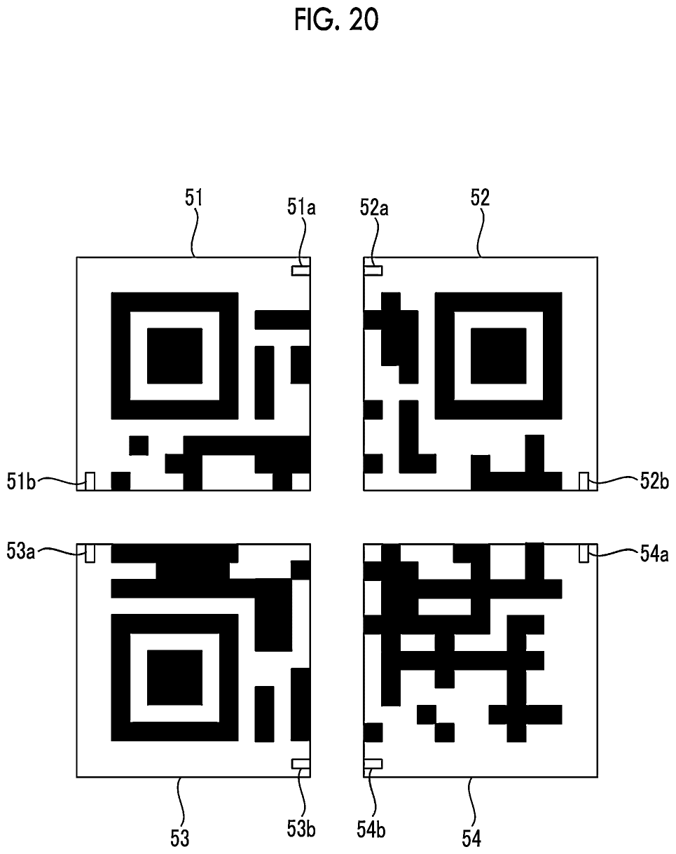

FIG. 19 is a sequence diagram illustrating a second example of the information delivery under the second control of the control device 14. While a configuration in which the upper left image 51, the upper right image 52, the lower left image 53, and the lower right image 54 obtained by dividing the two-dimensional code 50 are set as images of colors different from each other has been described, the present invention is not limited to this configuration.

For example, in executing the second control, the control device 14 may be configured to project a correspondence image indicating a correspondence relationship between projection timings (for example, projection time points or elapsed times from a reference time point) of the upper left image 51, the upper right image 52, the lower left image 53, and the lower right image 54 and the positions of the upper left image 51, the upper right image 52, the lower left image 53, and the lower right image 54 in the linking processing to the projection destination object 6. For example, the moving object 10 and the information reading apparatus 80 operate as illustrated in FIG. 19. FIGS. 20 to 26 are diagrams for describing each operation of the information delivery illustrated in FIG. 19.

As illustrated in FIG. 19, first, the moving object 10 divides the two-dimensional code 50 (step S71). For example, the moving object 10 generates each image data indicating the upper left image 51, the upper right image 52, the lower left image 53, and the lower right image 54 illustrated in FIG. 20 based on the two-dimensional code indicating the two-dimensional code 50 illustrated in FIG. 1. While the upper left image 51, the upper right image 52, the lower left image 53, and the lower right image 54 illustrated in FIG. 20 are the same as the upper left image 51, the upper right image 52, the lower left image 53, and the lower right image 54 illustrated in FIG. 6, the upper left image 51, the upper right image 52, the lower left image 53, and the lower right image 54 may be images of the same color (images of white and black).

FIG. 19 will be referred to again for description. Next, the moving object 10 projects a correspondence image indicating a correspondence relationship between each projection timing of the upper left image 51, the upper right image 52, the lower left image 53, and the lower right image 54 obtained by the division in step S71 and each position of the upper left image 51, the upper right image 52, the lower left image 53, and the lower right image 54 in the linking processing to the projection destination object 6 from the projection apparatus 11 (step S72).

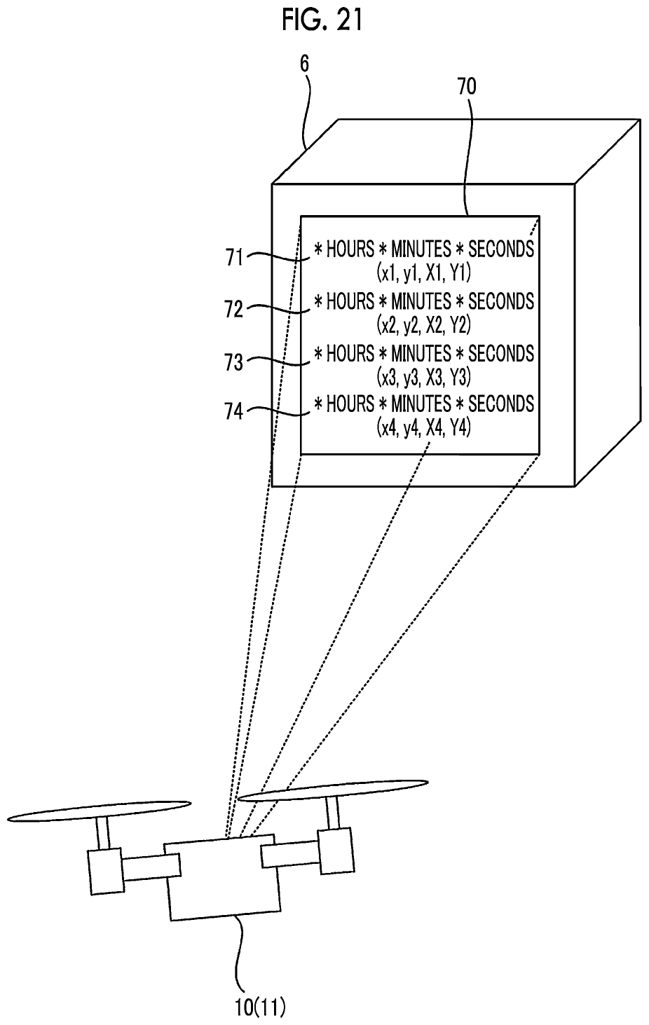

For example, the moving object 10 projects a correspondence image 70 illustrated in FIG. 21 to the projection destination object 6 from the projection apparatus 11. The correspondence image 70 includes a first projection time point and position image 71, a second projection time point and position image 72, a third projection time point and position image 73, and a fourth projection time point and position image 74.

The first projection time point and position image 71 is an image showing a first projection time point (* hours * minutes * seconds) that is the projection time point of the upper left image 51 and positional coordinates (x1, y1, X1, Y1) of the upper left image 51 in the linking processing as a text. The positional coordinates (x1, y1, X1, Y1) are, for example, coordinates indicating a region at the upper left in the image after the linking processing. The second projection time point and position image 72 is an image showing a second projection time point (* hours * minutes * seconds) that is the projection time point of the upper right image 52 and positional coordinates (x2, y2, X2, Y2) of the upper right image 52 in the linking processing as a text. The positional coordinates (x2, y2, X2, Y2) are, for example, coordinates indicating a region at the upper right in the image after the linking processing.

The third projection time point and position image 73 is an image showing a third projection time point (* hours * minutes * seconds) that is the projection time point of the lower left image 53 and positional coordinates (x3, y3, X3, Y3) of the lower left image 53 in the linking processing as a text. The positional coordinates (x3, y3, X3, Y3) are, for example, coordinates indicating a region at the lower left in the image after the linking processing. The fourth projection time point and position image 74 is an image showing a fourth projection time point (* hours * minutes * seconds) that is the projection time point of the lower right image 54 and positional coordinates (x4, y4, X4, Y4) of the lower right image 54 in the linking processing as a text. The positional coordinates (x4, y4, X4, Y4) are, for example, coordinates indicating a region at the lower right in the image after the linking processing.

Accordingly, by optically reading the correspondence image 70 via the imaging apparatus 83 and performing text recognition processing, the information reading apparatus 80 can recognize a correspondence relationship indicating that an image projected at the first projection time point (* hours * minutes *seconds) is at the positional coordinates (x1, y1, X1, Y1), an image projected at the second projection time point (* hours * minutes *seconds) is at the positional coordinates (x2, y2, X2, Y2), an image projected at the third projection time point (* hours * minutes *seconds) is at the positional coordinates (x3, y3, X3, Y3), and an image projected at the fourth projection time point (* hours * minutes *seconds) is at the positional coordinates (x4, y4, X4, Y4).

In addition, in this example, the correspondence image 70 also serves as the notification information for providing the notification of the start of divided display of the two-dimensional code 50 (second control) to the information reading apparatus 80. For example, the information reading apparatus 80 is configured to recognize that the divided display of the two-dimensional code 50 has started in a case where an image such as the correspondence image 70 having text information indicating the correspondence relationship between the projection time points and the positional coordinates is captured.

FIG. 19 will be referred to again for description. Next, the information reading apparatus 80 captures the correspondence image 70 projected to the projection destination object 6 (step S73). Next, the information reading apparatus 80 recognizes the start of the divided display of the two-dimensional code 50 (second control) and recognizes the correspondence relationship between the projection time points and the positions based on an imaging result of the correspondence image 70 (step S74).

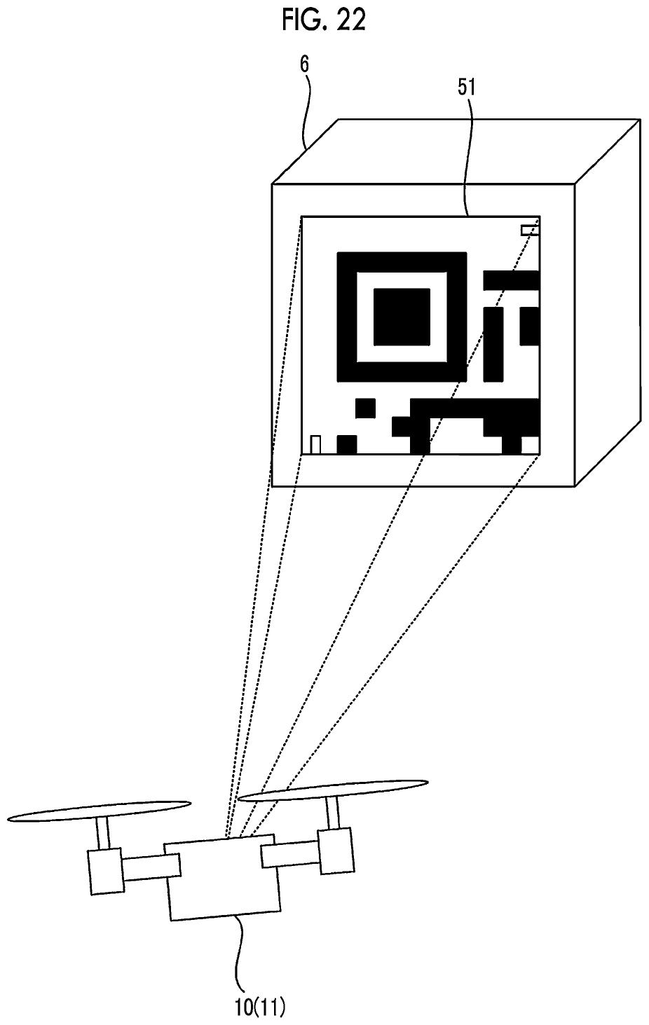

Meanwhile, the moving object 10 waits until the first projection time point shown in the first projection time point and position image 71 (step S75), and enlarges the upper left image 51 among the divided images obtained by the division in step S71 and projects the upper left image 51 to the projection destination object 6 from the projection apparatus 11 (step S76). For example, as illustrated in FIG. 22, the moving object 10 enlarges the upper left image 51 to have the same size as the two-dimensional code 50 illustrated in FIG. 1 and projects the upper left image 51 to the projection destination object 6.

Next, the information reading apparatus 80 captures the upper left image 51 projected to the projection destination object 6 (step S77). Next, the information reading apparatus 80 recognizes the upper left image 51 as the divided image at the upper left based on the correspondence relationship between the projection time points and the positions recognized in step S74 because the upper left image 51 is projected at the first projection time point (step S78).

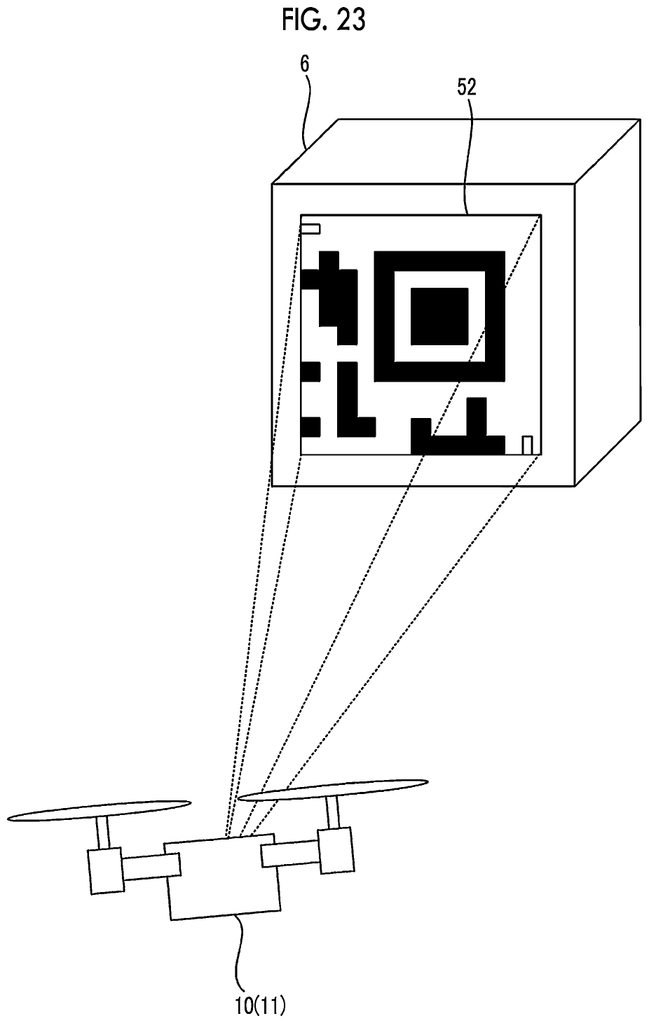

Meanwhile, the moving object 10 waits until the second projection time point shown in the second projection time point and position image 72 (step S79), and enlarges the upper right image 52 among the divided images obtained by the division in step S71 and projects the upper right image 52 to the projection destination object 6 from the projection apparatus 11 (step S80). For example, as illustrated in FIG. 23, the moving object 10 enlarges the upper right image 52 to have the same size as the two-dimensional code 50 illustrated in FIG. 1 and projects the upper right image 52 to the projection destination object 6.

Next, the information reading apparatus 80 captures the upper right image 52 projected to the projection destination object 6 (step S81). Next, the information reading apparatus 80 recognizes the upper right image 52 as the divided image at the upper right based on the correspondence relationship between the projection time points and the positions recognized in step S74 because the upper right image 52 is projected at the second projection time point (step S82).

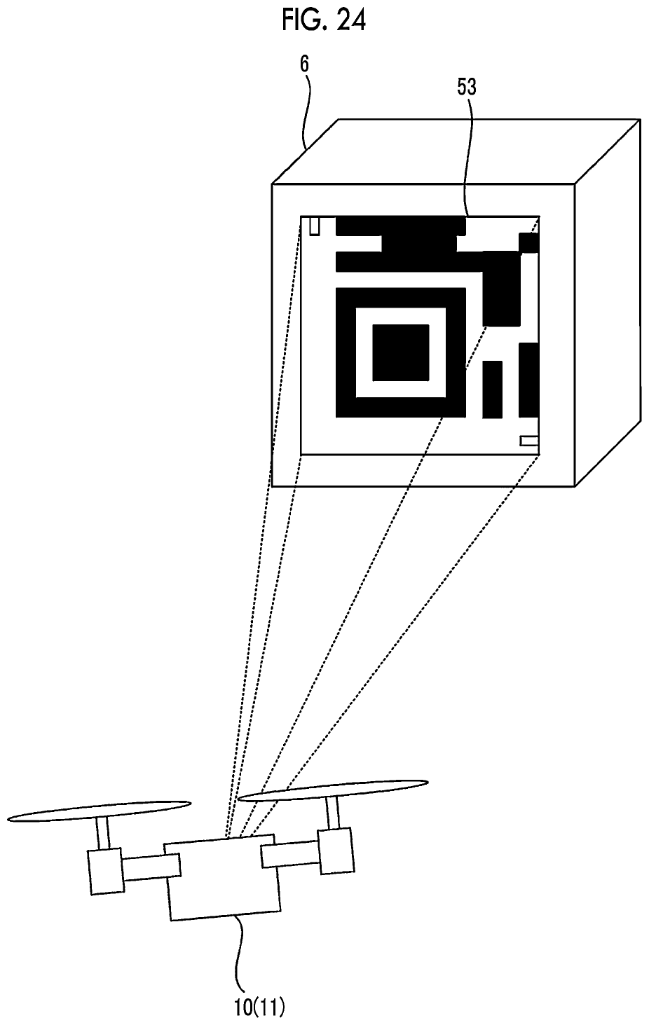

Meanwhile, the moving object 10 waits until the third projection time point shown in the third projection time point and position image 73 (step S83), and enlarges the lower left image 53 among the divided images obtained by the division in step S71 and projects the lower left image 53 to the projection destination object 6 from the projection apparatus 11 (step S84). For example, as illustrated in FIG. 24, the moving object 10 enlarges the lower left image 53 to have the same size as the two-dimensional code 50 illustrated in FIG. 1 and projects the lower left image 53 to the projection destination object 6.

Next, the information reading apparatus 80 captures the lower left image 53 projected to the projection destination object 6 (step S85). Next, the information reading apparatus 80 recognizes the lower left image 53 as the divided image at the lower left based on the correspondence relationship between the projection time points and the positions recognized in step S74 because the lower left image 53 is projected at the third projection time point (step S86).

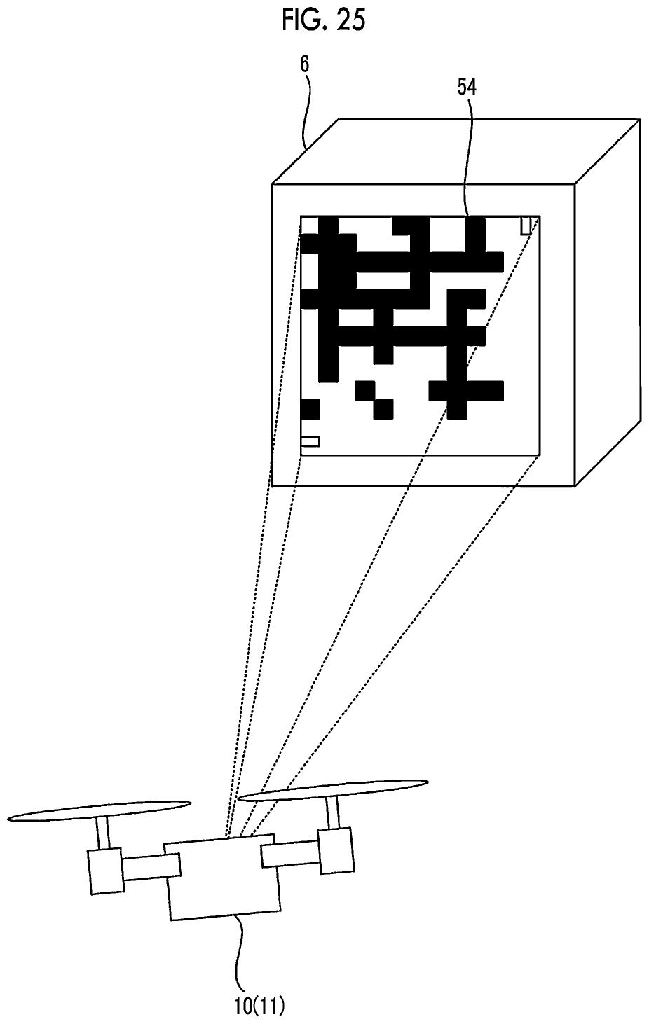

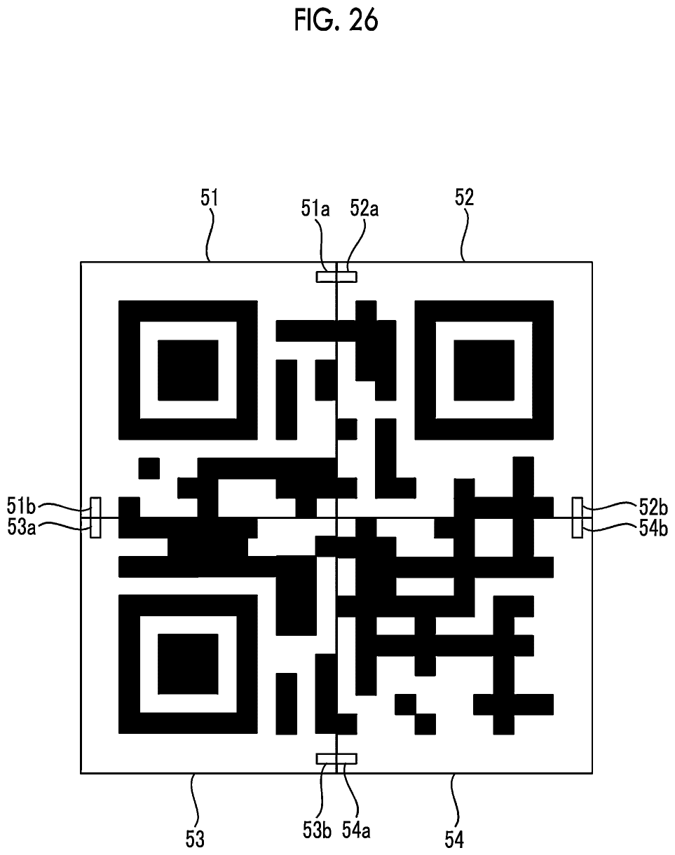

Meanwhile, the moving object 10 waits until the fourth projection time point shown in the fourth projection time point and position image 74 (step S87), and enlarges the lower right image 54 among the divided images obtained by the division in step S71 and projects the lower right image 54 to the projection destination object 6 from the projection apparatus 11 (step S88). For example, as illustrated in FIG. 25, the moving object 10 enlarges the lower right image 54 to have the same size as the two-dimensional code 50 illustrated in FIG. 1 and projects the lower right image 54 to the projection destination object 6.

Next, the information reading apparatus 80 captures the lower right image 54 projected to the projection destination object 6 (step S89). Next, the information reading apparatus 80 recognizes the lower right image 54 as the divided image at the lower right based on the correspondence relationship between the projection time points and the positions recognized in step S74 because the lower right image 54 is projected at the fourth projection time point (step S90).

Steps S91 to S95 are the same as steps S31 to S35 illustrated in FIG. 5. However, in step S94, the information reading apparatus 80, for example, performs the linking processing as illustrated in FIG. 26. Specifically, the information reading apparatus 80 arranges the upper left image 51, the upper right image 52, the lower left image 53, and the lower right image 54 at the upper left, the upper right, the lower left, and the lower right, respectively, based on recognition results in steps S78, S82, S86, and S90. In addition, the information reading apparatus 80 finely adjusts the relative position of each of the upper left image 51, the upper right image 52, the lower left image 53, and the lower right image 54 using the alignment marks 51a, 51b, 52a, 52b, 53a, 53b, 54a, and 54b. Accordingly, an image of the state illustrated in FIG. 26 is obtained.

Furthermore, the information reading apparatus 80 may perform processing of removing the alignment marks 51a, 51b, 52a, 52b, 53a, 53b, 54a, and 54b. Accordingly, the information reading apparatus 80 can obtain two-dimensional code data indicating a two-dimensional code equivalent to the two-dimensional code 50 illustrated in FIG. 1.

As described above, the control device 14 may perform a control of projecting the plurality of images (the upper left image 51, the upper right image 52, the lower left image 53, and the lower right image 54) obtained by the division and the correspondence image 70 indicating the correspondence relationship between the projection timings of the plurality of images and the positions of the plurality of images in the linking processing at different timings. Accordingly, the correspondence relationship can be delivered to the information reading apparatus 80 from the control device 14 without performing communication in advance between the control device 14 and the information reading apparatus 80. In addition, since color separation of the projection image, color extraction from the projection image, and the like can be omitted, configurations of the projection apparatus 11 and the information reading apparatus 80 can be simplified.

### Third Example of Information Delivery Under Second Control of Control Device 14

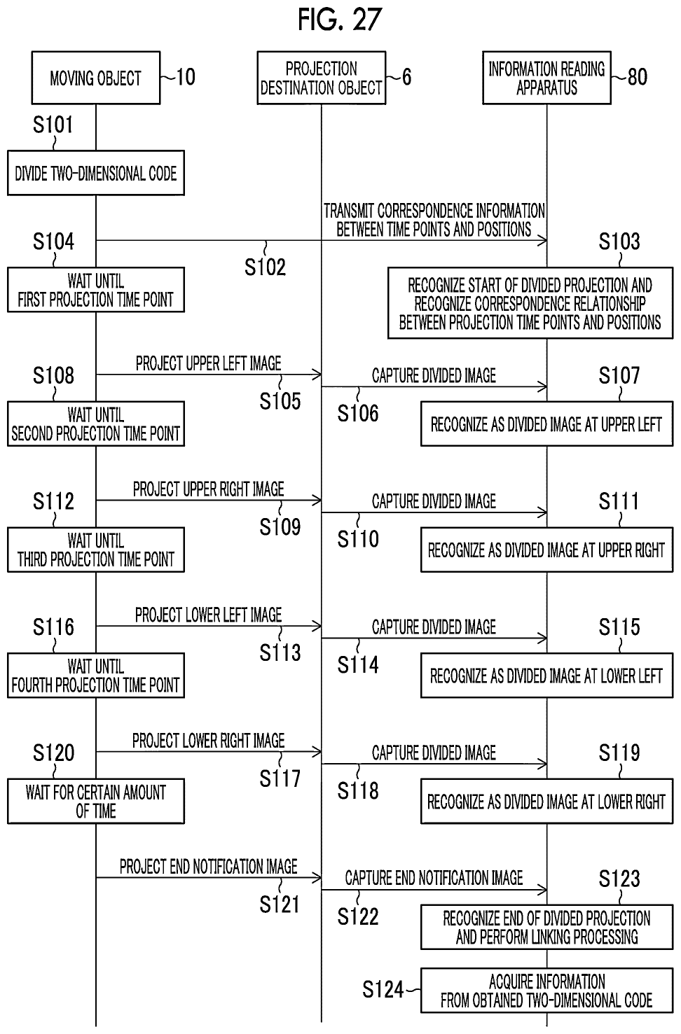

FIG. 27 is a sequence diagram illustrating a third example of the information delivery under the second control of the control device 14. While a configuration in which the notification of the correspondence relationship between the projection time points and the positions is provided to the information reading apparatus 80 from the moving object 10 by projecting the correspondence image 70 has been described, the present invention is not limited to this configuration. For example, in executing the second control, the control device 14 may be configured to transmit a correspondence information indicating the correspondence relationship between the projection timings (for example, the projection time points or the elapsed times from the reference time point) of the upper left image 51, the upper right image 52, the lower left image 53, and the lower right image 54 and the positions of the upper left image 51, the upper right image 52, the lower left image 53, and the lower right image 54 in the linking processing to the information reading apparatus 80. For example, the moving object 10 and the information reading apparatus 80 operate as illustrated in FIG. 27.

As illustrated in FIG. 27, first, the moving object 10 divides the two-dimensional code 50 (step S101). The division of the two-dimensional code 50 in step S101 is the same as, for example, the division of the two-dimensional code 50 illustrated in FIGS. 19 and 20.

Next, the moving object 10 transmits the correspondence information indicating the correspondence relationship between each projection timing of the upper left image 51, the upper right image 52, the lower left image 53, and the lower right image 54 obtained by the division in step S101 and each position of the upper left image 51, the upper right image 52, the lower left image 53, and the lower right image 54 in the linking processing to the information reading apparatus 80 (step S102). For example, the transmission of the correspondence information to the information reading apparatus 80 from the moving object 10 is performed by wireless communication between the communication unit 15 of the moving object 10 and the communication interface 84 of the information reading apparatus 80. In addition, in this example, the correspondence information also serves as the notification information for providing the notification of the start of divided display of the two-dimensional code 50 (second control) to the information reading apparatus 80. For example, the information reading apparatus 80 is configured to recognize that the divided display of the two-dimensional code 50 has started in a case where the correspondence information is received.

Next, the information reading apparatus 80 recognizes the start of the divided display of the two-dimensional code 50 (second control) and recognizes the correspondence relationship between the projection time points and the positions based on the correspondence information received from the moving object 10 (step S103). Steps S104 to S124 are the same processing as steps S75 to S95 illustrated in FIG. 19. However, instead of steps S120 to S122, processing of transmitting end notification information for providing the notification of the end of the divided display of the two-dimensional code 50 (second control) to the information reading apparatus 80 from the moving object 10 may be performed. For example, the transmission of the end notification information to the information reading apparatus 80 from the moving object 10 is performed by wireless communication between the communication unit 15 of the moving object 10 and the communication interface 84 of the information reading apparatus 80.

As described above, the control device 14 may perform a control of transmitting the correspondence information indicating the correspondence relationship between the projection timings of the plurality of images (the upper left image 51, the upper right image 52, the lower left image 53, and the lower right image 54) obtained by the division and the positions of the plurality of images in the linking processing to the information reading apparatus 80.

### Circumstance in Which Projection Range is Limited by Obstacle Between Moving Object 10 and Projection Destination Object 6

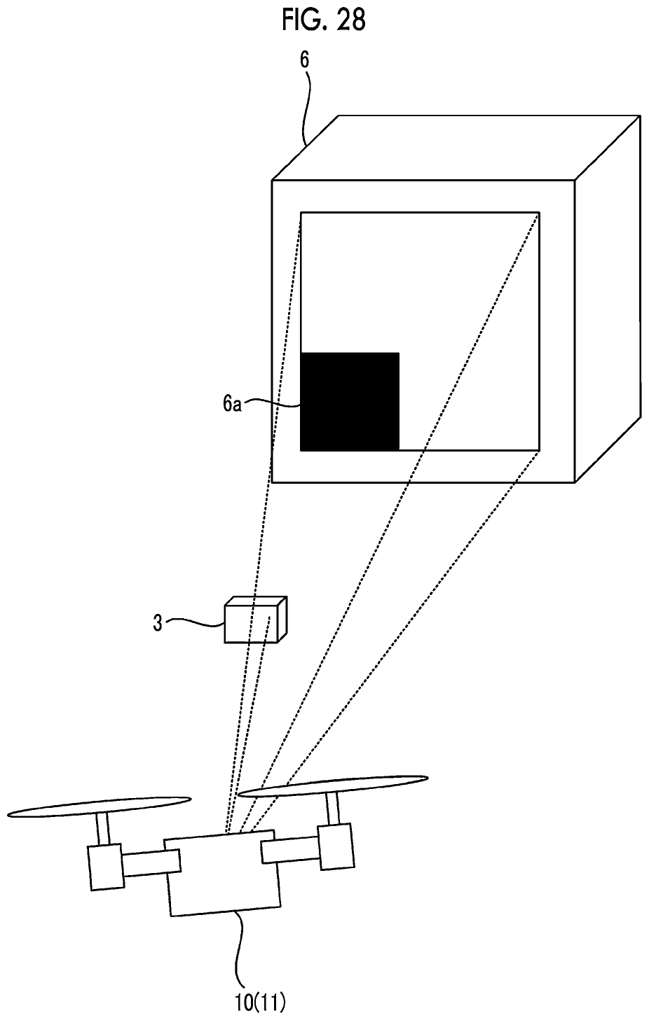

FIG. 28 is a diagram illustrating an example of a circumstance in which the projection range is limited by an obstacle between the moving object 10 and the projection destination object 6. As illustrated in FIG. 28, there may be a circumstance in which a shadow 6a is formed on the projection destination object 6 by an obstacle 3 between the moving object 10 and the projection destination object 6, and the image is not projected to a part of the projection destination object 6 corresponding to the shadow 6a. In this circumstance, for example, it is difficult to project the correspondence image 70 as illustrated in FIG. 21. However, in the example in FIG. 27, the notification of the correspondence relationship between the projection timings and the positions can be provided to the information reading apparatus 80 from the moving object 10 by transmitting the correspondence information to the information reading apparatus 80 from the moving object 10 using wireless communication. In addition, in this case, the control device 14 recognizes the obstacle 3 or the shadow 6a using image recognition processing based on the imaging data obtained by the imaging apparatus 12 and performs a control of performing the projection to a part of the projection destination object 6 excluding the shadow 6a.

### Fourth Example of Information Delivery Under Second Control of Control Device 14

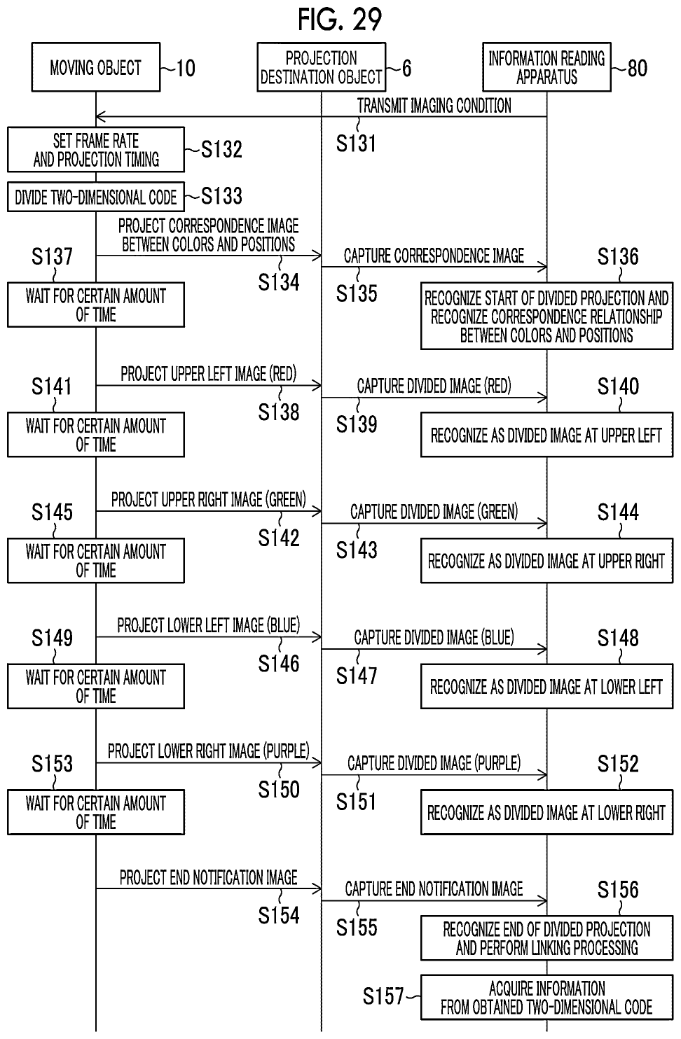

FIG. 29 is a sequence diagram illustrating a fourth example of the information delivery under the second control of the control device 14. The control device 14 may receive information indicating an imaging condition of the imaging apparatus 83 of the information reading apparatus 80 from the information reading apparatus 80 and perform the projection under the second control based on the imaging condition of the imaging apparatus 83. For example, the moving object 10 and the information reading apparatus 80 operate as illustrated in FIG. 29.

First, the information reading apparatus 80 transmits the information indicating the imaging condition to the moving object 10 (step S131). The imaging condition is, for example, a frame rate or an exposure time (shutter speed) of the imaging. For example, the transmission of the information indicating the imaging condition to the moving object 10 from the information reading apparatus 80 is performed by wireless communication between the communication interface 84 of the information reading apparatus 80 and the communication unit 15 of the moving object 10.

Next, the moving object 10 sets a frame rate and a projection timing of the projection of the projection apparatus 11 based on the imaging condition of the imaging apparatus 83 indicated by the information received in step S131 (step S132). For the frame rate of the projection, for example, the projection apparatus 11 repeatedly projects the same image to project the image as a static image, and the frame rate of the projection is a speed at which the projection is repeated. The projection timing is, for example, each projection timing of the correspondence image 60, the upper left image 51, the upper right image 52, the lower left image 53, the lower right image 54, and the end notification image.

For example, the moving object 10 sets a frame rate less than or equal to the frame rate in the imaging of the imaging apparatus 83 as the frame rate of the projection of the projection apparatus 11. In addition, the moving object 10 sets each projection timing of the projection apparatus 11 based on the frame rate, the exposure time, or the like of the imaging of the imaging apparatus 83 such that the information reading apparatus 80 can recognize each of the correspondence image 60, the upper left image 51, the upper right image 52, the lower left image 53, the lower right image 54, and the end notification image.

Steps S133 to S157 are the same processing as steps S11 to S35 illustrated in FIG. 5. However, in steps S134, S138, S142, S146, S150, and S154, the moving object 10 performs the projection using the frame rate and the projection timing set in step S132.

As described above, the control device 14 may receive the information indicating the imaging condition of the imaging apparatus 83 of the information reading apparatus 80 from the information reading apparatus 80 and project each image including the plurality of images based on the imaging condition of the imaging apparatus 83. Accordingly, the moving object 10 can set an appropriate projection condition corresponding to the imaging condition of the imaging apparatus 83 in the projection apparatus 11 and perform the projection.

### Fifth Example of Information Delivery Under Second Control of Control Device 14

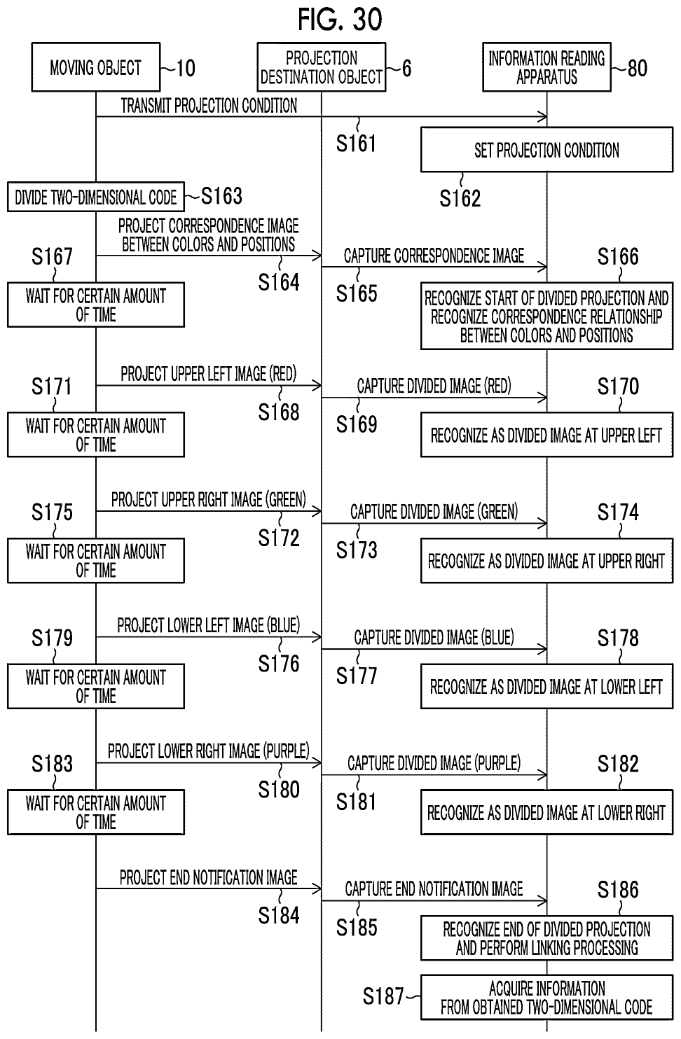

FIG. 30 is a sequence diagram illustrating a fifth example of the information delivery under the second control of the control device 14. The control device 14 may transmit information indicating the projection condition of the image for the projection apparatus 11 to the information reading apparatus 80. For example, the moving object 10 and the information reading apparatus 80 operate as illustrated in FIG. 30.

First, the moving object 10 transmits the information indicating the projection condition of the image for the projection apparatus 11 to the information reading apparatus 80 (step S161). Examples of the projection condition include the frame rate and brightness of the projection. For example, the transmission of the information indicating the projection condition to the information reading apparatus 80 from the moving object 10 is performed by wireless communication between the communication unit 15 of the moving object 10 and the communication interface 84 of the information reading apparatus 80.

Next, the information reading apparatus 80 sets the imaging condition of the imaging apparatus 83 based on the projection condition indicated by the information received in step S161 (step S162). For example, the information reading apparatus 80 sets a frame rate greater than or equal to the frame rate of the projection of the projection apparatus 11 as the frame rate of the imaging of the imaging apparatus 83. In addition, exposure is set to be higher (brighter) as the brightness of the projection of the projection apparatus 11 is decreased.

Steps S163 to S187 are the same processing as steps S11 to S35 illustrated in FIG. 5. However, in steps S165, S169, S173, S177, S181, and S185, the imaging apparatus 83 of the moving object 10 performs the imaging under the imaging condition set in step S162.

As described above, the control device 14 may perform a control of transmitting the information indicating the projection condition of the image for the projection apparatus 11 to the information reading apparatus 80. Accordingly, the information reading apparatus 80 can set the imaging condition corresponding to the projection condition of the image for the projection apparatus 11 in the imaging apparatus 83 and capture the image projected by the projection apparatus 11.

### Other Application Examples of Control Device

While a case where the control device according to the embodiment of the present invention is applied to the control device 14 of the moving object 10 has been described, the present invention is not limited to this configuration.

### Control Device 110 to Which Control Device According to Present Invention is Applied

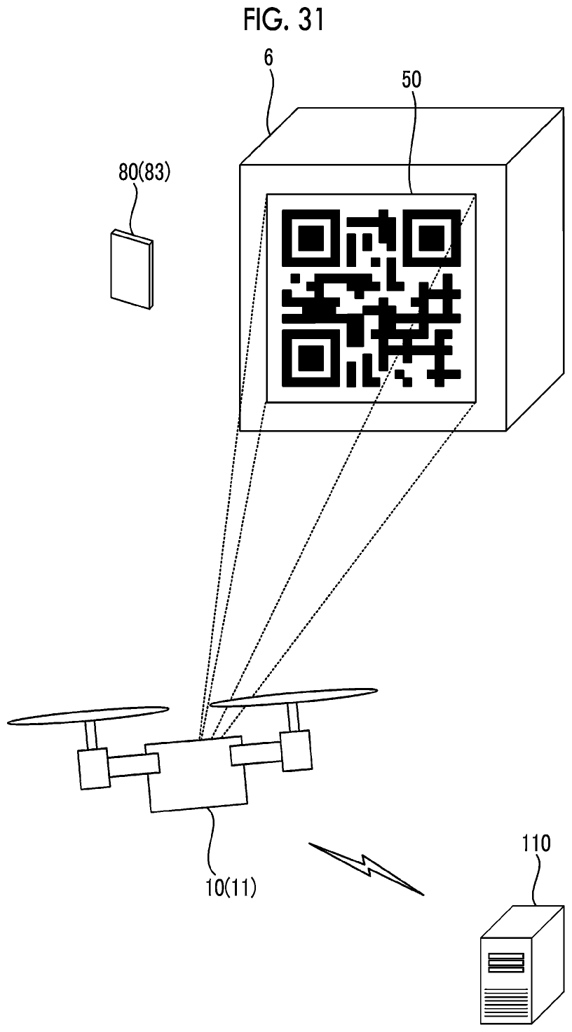

FIG. 31 is a diagram illustrating an example of a control device 110 to which the control device according to the embodiment of the present invention is applied. The control device according to the embodiment of the present invention may be applied to, for example, the control device 110 illustrated in FIG. 31.

The control device 110 is a device that can directly or indirectly communicate with the moving object 10. The communication between the control device 110 and the projection apparatus 11 is, for example, wireless communication. In addition, the communication between the control device 110 and the projection apparatus 11 may be direct communication or communication through other communication devices or networks.

The control device 110 executes the same controls as the various controls of the control device 14 by communicating with the moving object 10. The control device 110 can be various devices such as a server apparatus, a desktop personal computer, a laptop personal computer, a smartphone, and a tablet terminal.

### Hardware Configuration of Control Device 110

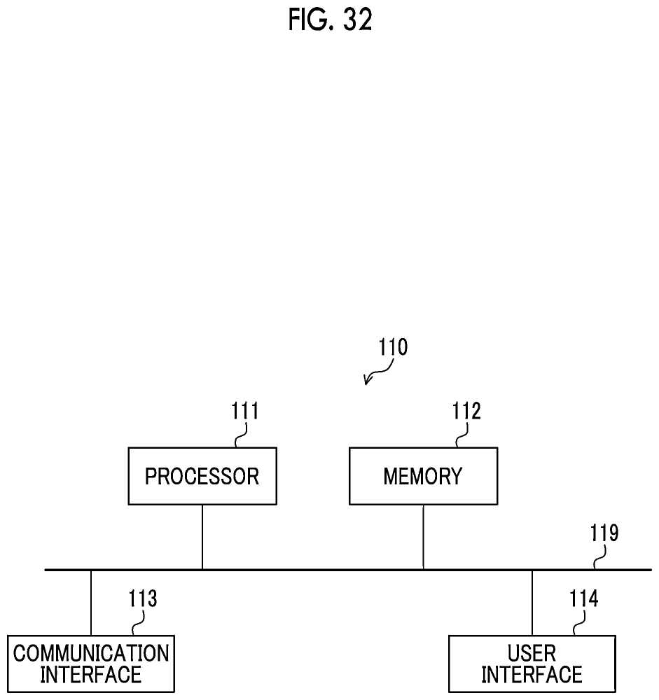

FIG. 32 is a diagram illustrating an example of a hardware configuration of the control device 110. For example, as illustrated in FIG. 17, the control device 110 illustrated in FIG. 31 comprises a processor 111, a memory 112, a communication interface 113, and a user interface 114. The processor 111, the memory 112, the communication interface 113, and the user interface 114 are connected to each other through, for example, a bus 119.

The processor 111, the memory 112, the communication interface 113, and the user interface 114 have the same configurations as, for example, the processor 81, the memory 82, the communication interface 84, and the user interface 85 of the information reading apparatus 80 illustrated in FIG. 4. The communication interface 113 communicates with, for example, the moving object 10.

### Modification Example of Information Image

While the two-dimensional code 50 has been described as an example of the information image, the information image is not limited to the two-dimensional code 50. For example, the information image may be a two-dimensional code of a different form from the two-dimensional code 50 or a one-dimensional code.

### Modification Example of Divided Images

While a configuration in which the upper left image 51, the upper right image 52, the lower left image 53, and the lower right image 54 are images obtained by dividing the two-dimensional code 50 has been described, the present invention is not limited to this configuration. For example, the upper left image 51, the upper right image 52, the lower left image 53, and the lower right image 54 may be images stored in advance in the control device 14 or other devices.

In addition, the two-dimensional code obtained by combining the upper left image 51, the upper right image 52, the lower left image 53, and the lower right image 54 projected under the second control may not be exactly the same image as the two-dimensional code 50 projected under the first control and may be an image from which substantially the same information as the two-dimensional code 50 is obtained by reading the image in the information reading apparatus 80.

### Modification Example of Enlargement of Divided Images

While a configuration in which each of the upper left image 51, the upper right image 52, the lower left image 53, and the lower right image 54 is enlarged to have the same size as the two-dimensional code 50 and projected in the second control has been described, the present invention is not limited to this configuration. For example, the control device 14 may slightly enlarge and project each of the upper left image 51, the upper right image 52, the lower left image 53, and the lower right image 54 in the second control.

### Modification Example of Divided Images

While a configuration in which the alignment marks 51a and 51b, the alignment marks 52a and 52b, the alignment marks 53a and 53b, and the alignment marks 54a and 54b are attached to the upper left image 51, the upper right image 52, the lower left image 53, and the lower right image 54, respectively, has been described, the present invention is not limited to this configuration. For example, the number, shapes, sizes, and positions of alignment marks to be attached to the upper left image 51, the upper right image 52, the lower left image 53, and the lower right image 54 may be changed, as appropriate. In addition, a configuration in which alignment marks are not attached to the upper left image 51, the upper right image 52, the lower left image 53, and the lower right image 54 may also be employed.

### Modification Example of Combining of Images

While the linking processing of combining the plurality of images by arranging the plurality of images adjacent to each other has been described as processing of combining for obtaining the information image from the plurality of images has been described, the processing of combining for obtaining the information image from the plurality of images is not limited to the linking processing. For example, the processing of combining for obtaining the information image from the plurality of images may be processing of combining the plurality of images by arranging the plurality of images to be partially superimposed on each other.

### Modification Example of Moving Object 10

While a configuration in which the moving object 10 is a multicopter has been described, the moving object 10 may be an aircraft (flying object) other than a multicopter. In addition, the moving object 10 is not limited to a flying object and may be a vehicle, a robot, or the like that travels or walks on the ground.

### Modification Example of Projection Apparatus 11

While a configuration in which the projection apparatus 11 is mounted on the moving object 10 has been described, the present invention is not limited to this configuration. For example, the projection apparatus 11 may be a projection apparatus fixed on the ground.

At least the following matters are described in the present specification.
(1)

A control device that controls a projection apparatus, the control device comprising a processor, in which the processor is configured to acquire a plurality of pieces of image data indicating a plurality of images that are combined to form an information image, and perform a control of projecting the plurality of images from the projection apparatus at different timings.
(2)

The control device according to (1), in which the plurality of images include a first image and a second image, and the processor is configured to project the first image at an earlier timing than the second image, and start projecting the second image after a time of an end of the projection of the first image.
(3)

The control device according to (1) or (2), in which the processor is configured to switch between a first control of projecting the information image from the projection apparatus and a second control of projecting the plurality of images from the projection apparatus at different timings based on a distance between the projection apparatus and a projection destination object.
(4)

The control device according to (3), in which a focal length of projection is changeable in the projection apparatus, and the processor is configured to switch between the first control and the second control based on the distance between the projection apparatus and the projection destination object and on a range in which the focal length is changeable.
(5)

The control device according to any one of (1) to (4), in which the plurality of images have different colors, and the processor is configured to perform a control of projecting the plurality of images and a correspondence image indicating a correspondence relationship between the colors of the plurality of images and positions of the plurality of images in the combining from the projection apparatus at different timings.
(6)

The control device according to any one of (1) to (5), in which the processor is configured to perform a control of projecting the plurality of images and a correspondence image indicating a correspondence relationship between projection timings of the plurality of images and positions of the plurality of images in the combining at different timings.
(7)

The control device according to any one of (1) to (6), in which the control device is capable of communicating with an information reading apparatus including an imaging unit capable of imaging a projection destination object, and the processor is configured to perform a control of transmitting correspondence information indicating a correspondence relationship between projection timings of the plurality of images and positions of the plurality of images in the combining to the information reading apparatus.
(8)

The control device according to any one of (1) to (7), in which at least any of the plurality of images includes a registration image indicating a positional relationship among the plurality of images in the combining.
(9)

The control device according to any one of (1) to (8), in which the processor is configured to set the number of images to be included in the plurality of images based on a distance between the projection apparatus and a projection destination object.
(10)

The control device according to any one of (1) to (9), in which the control device is capable of communicating with an information reading apparatus including an imaging unit capable of imaging a projection destination object of the projection apparatus, and the processor is configured to receive information indicating an imaging condition of the imaging unit from the information reading apparatus and project the plurality of images from the projection apparatus based on the imaging condition.
(11)

The control device according to any one of (1) to (10), in which the control device is capable of communicating with an information reading apparatus including an imaging unit capable of imaging a projection destination object of the projection apparatus, and the processor is configured to perform a control of transmitting information indicating a projection condition of the plurality of images for the projection apparatus to the information reading apparatus.
(12)

The control device according to any one of (1) to (11), in which the projection apparatus is mounted on a moving object.
(13)

The control device according to any one of (1) to (12), in which the processor is configured to perform a control of projecting the plurality of images and an image different from the plurality of images from the projection apparatus at different timings.
(14)

A control method performed by a processor of a control device that controls a projection apparatus, the control method comprising acquiring a plurality of pieces of image data indicating a plurality of images that are combined to form an information image, and performing a control of projecting the plurality of images from the projection apparatus at different timings.
(15)

A control program for causing a processor of a control device that controls a projection apparatus to execute a process comprising acquiring a plurality of pieces of image data indicating a plurality of images that are combined to form an information image, and performing a control of projecting the plurality of images from the projection apparatus at different timings.

While various embodiments have been described above, the present invention is, of course, not limited to such examples. It is apparent that those skilled in the art may perceive various modification examples or correction examples within the scope disclosed in the claims, and those examples are also understood as falling within the technical scope of the present invention. In addition, constituents in the embodiments may be combined with each other in any manner without departing from the gist of the invention.

The present application is based on Japanese Patent Application (JP2021-212602) filed on Dec. 27, 2021, the content of which is incorporated in the present application by reference.

### Explanation of References

3: obstacle
6: projection destination object
6a: shadow
10: moving object
11: projection apparatus
12, 83: imaging apparatus
14, 110: control device
14a: storage medium
15: communication unit
16: moving mechanism
21: red color component
22: green color component
23: blue color component
24: purple color component
31: light source
32: optical modulation unit
33: projection optical system
34: control circuit
50: two-dimensional code
51: upper left image
52: upper right image
53: lower left image
54: lower right image
51a, 51b, 52a, 52b, 53a, 53b, 54a, 54b: alignment mark
60, 70: correspondence image
61: upper left region
62: upper right region
63: lower left region
64: lower right region
71: first projection time point and position image
72: second projection time point and position image
73: third projection time point and position image
74: fourth projection time point and position image
80: information reading apparatus
81. 111: processor
82. 112: memory
84. 113: communication interface
85. 114: user interface
89. 119: bus
B1 to B3: brightness region

What is claimed is:

1. A control device that controls a projection apparatus, the control device comprising:
a processor,
wherein the processor is configured to:
acquire a plurality of pieces of image data indicating a plurality of images that are to be linked to each other to form an information image; and
perform a control of projecting the plurality of images to overlapping projection regions from the projection apparatus at different timings.

2. The control device according to claim 1,
wherein the plurality of images include a first image and a second image, and
the processor is configured to:
project the first image at an earlier timing than the second image; and
start projecting the second image after a time of an end of the projection of the first image.

3. The control device according to claim 1,
wherein the processor is configured to switch between a first control of projecting the information image from the projection apparatus and a second control of projecting the plurality of images from the projection apparatus at different timings, based on a distance between the projection apparatus and a projection destination object.

4. The control device according to claim 3,
wherein a focal length of projection is changeable in the projection apparatus, and
the processor is configured to switch between the first control and the second control based on the distance between the projection apparatus and the projection destination object and on a range in which the focal length is changeable.

5. The control device according to claim 1,
wherein the plurality of images have different colors, and
the processor is configured to perform a control of projecting, from the projection apparatus at different timings, the plurality of images and a correspondence image indicating a correspondence relationship between the colors of the plurality of images and positions of the plurality of images in the linking.

6. The control device according to claim 1,
wherein the processor is configured to perform a control of projecting, at different timings, the plurality of images and a correspondence image indicating a correspondence relationship between projection timings of the plurality of images and positions of the plurality of images in the linking.

7. The control device according to claim 1,
wherein the control device is capable of communicating with an information reading apparatus including an imager capable of imaging a projection destination object, and the processor is configured to perform a control of transmitting, to the information reading apparatus, correspondence information indicating a correspondence relationship between projection timings of the plurality of images and positions of the plurality of images in the linking.

8. The control device according to claim 1,
wherein at least one of the plurality of images includes a registration image indicating a positional relationship among the plurality of images in the linking.

9. The control device according to claim 1,
wherein the processor is configured to set number of images to be included in the plurality of images based on a distance between the projection apparatus and a projection destination object.

10. The control device according to claim 1,
wherein the control device is capable of communicating with an information reading apparatus including an imager capable of imaging a projection destination object of the projection apparatus, and
the processor is configured to receive information indicating an imaging condition of the imager from the information reading apparatus and project the plurality of images from the projection apparatus based on the imaging condition.

11. The control device according to claim 1,
wherein the control device is capable of communicating with an information reading apparatus including an imager capable of imaging a projection destination object of the projection apparatus, and
the processor is configured to perform a control of transmitting, to the information reading apparatus, information indicating a projection condition of the plurality of images for the projection apparatus.

12. The control device according to claim 1,
wherein the projection apparatus is mounted on a moving object.

13. The control device according to claim 1,
wherein the processor is configured to perform a control of projecting, from the projection apparatus at different timings, the plurality of images and an image different from the plurality of images.

14. A control method performed by a processor of a control device that controls a projection apparatus, the control method comprising:
acquiring a plurality of pieces of image data indicating a plurality of images that are to be linked to each other to form an information image; and
performing a control of projecting the plurality of images to overlapping projection regions from the projection apparatus at different timings.

15. A non-transitory computer readable medium storing a control program for causing a processor of a control device that controls a projection apparatus to execute a process comprising:
acquiring a plurality of pieces of image data indicating a plurality of images that are to be linked to each other to form an information image; and
performing a control of projecting the plurality of images to overlapping projection regions from the projection apparatus at different timings.
